(19) United States
(12) Patent Application Publication
(10) Pub. No.: US 2023/0303765 A1
(43) Pub. Date: Sep. 28, 2023

(54) A POLYESTER MOLDING HAVING A LOW OUTGASSING OF VOLATILE ORGANIC COMPOUNDS

(71) Applicant: BASF SE, Ludwigshafen (DE)

(72) Inventors: Erik Gubbels, Ludwigshafen (DE); Maximillian Lehenmeier, Ludwigshafen (DE); Alvaro Gordillo Bolonio, Barcelona (ES)

(21) Appl. No.: 18/019,120

(22) PCT Filed: Aug. 2, 2021
(86) PCT No.: PCT/EP2021/071564

§ 371 Date: Feb. 1, 2023

(30) Foreign Application Priority Data
Aug. 3, 2020 (EP) 20189080.3

(51) Int. Cl. C08G 63/183; C08K 3/34; B29C 48/00; C08L 67/02

(52) U.S. Cl. CPC C08G 63/183; C08K 3/34; B29C 48/022; C08L 67/02; B29K 2067/04

(57) ABSTRACT

The present invention relates to a molding comprising (i) a poly(butylene dicarboxylate) polyester in an amount in the range of from equal to or greater than 10 to 99.99 weight-%, based on the total weight of the molding, (ii) a zeolitic material in an amount of from 0.01 to 10 weight-%, based on the total weight of the molding, wherein the zeolitic material comprises YO₂ and optionally X₂O₃, wherein Y is a tetravalent element and X is a trivalent element, wherein the zeolitic material has a YO₂ to X₂O₃ molar ratio of higher than 100 if the zeolitic material comprises X₂O₃. Further, the present invention relates to a process for preparation of such a molding and use thereof.

### TECHNICAL FIELD

The present invention relates to a molding comprising (i) a poly(butylene dicarboxylate) polyester in an amount in the range of from equal to or greater than 10 to 99.99 weight-%, based on the total weight of the molding, (ii) a zeolitic material in an amount of from 0.01 to 10 weight-%, based on the total weight of the molding, wherein the zeolitic material comprises YO₂ and optionally X₂O₃, wherein Y is a tetravalent element and X is a trivalent element, wherein the zeolitic material has a YO₂ to X₂O₃ molar ratio of higher than 100 if the zeolitic material comprises X₂O₃. Further, the present invention relates to the preparation of said molding and use thereof in particular for applications which require low VOC emissions.

### INTRODUCTION

An inherent problem of polyesters is the outgassing of volatile organic compounds (VOC). For example, polyesters containing building units derived from 1,4-butanediol (e.g. poly(butylene terephthalate) (PBT)) can emit volatile organic compounds, wherein in particular tetrahydrofuran typically account for more than 95% of the total VOC. Other volatile organic compounds that may be emitted are for example butadiene, acetaldehyde, furan, acrolein, methanol, 1-butene-4-ol, and derivatives of tetrahydrofuran. Tetrahydrofuran (THF) usually results from the so called “back-biting” reaction of the building units derived from 1,4-butanediol, in particular from said building units forming end-groups of a polyester. Depolymerization processes of this type take place in particular when polyesters are kept for long periods in the melt or are processed under extreme conditions, e. g. at a high temperature, under a high pressure, or the like.

The outgassing of volatile organic compounds, in particular of THF, limits the use of such polyesters since migration limits are set in particular in the European Union. More specifically, in food contact and medical applications the European Union has set a specific migration limit for THF. Moreover, in the transportation sector the THF levels are set by in-vehicle air quality standards and said levels are continuously lowered, usually every few years. Current polyester materials containing 1,4-butanediol building units exhibit a comparatively high outgassing, whereby levels are reached which would often exceed a regulatory threshold.

EP 3004242 B1 relates to polyester molding compositions with a comparatively low total organic carbon (TOC) emission. In particular, a thermoplastic molding composition is disclosed which comprises a specific amount of a polyester composed of at least one polyalkylene terephthalate, a further polyester, an acrylic acid polymer composed of an acrylic acid and at least one other ethylenically unsaturated monomer.

JP 2019 014826 A relates to a composite comprising a resin and either a RHO-type zeolite, a molecular sieve 13X, an LTA-type zeolite, or a high silica zeolite. The resin may be a thermoplastic resin, and in particular comprise a polybutylene terephthalate resin. It is disclosed that said composite has a low linear thermal expansion coefficient.

WO 2019/189337 A1 relates to an odor adsorbent molded article resin composition comprising at least a thermoplastic resin A and an odor adsorbent, wherein the odor adsorbent comprises a hydrophobic zeolite having a SiO₂/Al₂O₃ molar ratio of 30/1 to 8000/1, wherein the melt flow rate of the thermoplastic resin A is in the range of from 5 to 100 g/min.

### DETAILED DESCRIPTION

It was therefore an object of the present invention to provide a novel molding which exhibits reduced emissions of volatile organic compounds, thus exhibiting in particular improved properties with respect to its emissions of total organic carbon. It was a particular subject of the present invention to provide a novel molding exhibiting reduced emissions of volatile organic compounds, and more particularly reduced emissions of tetrahydrofuran. Further, it was an object to provide a process for preparing such a novel molding.

Surprisingly, it has been found that a novel molding comprising a poly(butylene dicarboxylate) polyester and a specific zeolitic material exhibits reduced emissions of total organic carbon, in particular of volatile organic compounds, and more particularly of tetrahydrofuran. It has been particularly found that a novel molding can be provided according to the present invention which shows particularly improved properties with respect to the emissions of volatile organic compounds, in particular of tetrahydrofuran, when tested according to VDA277 being especially designed for the determination of automotive volatile organic compounds.

Therefore, the present invention relates to a molding comprising,
(i) a poly(butylene dicarboxylate) polyester in an amount in the range of from equal to or greater than 10 to 99.99 weight-%, based on the total weight of the molding,
(ii) a zeolitic material in an amount of from 0.01 to 10 weight-%, based on the total weight of the molding,
   wherein the zeolitic material comprises YO₂ and optionally X₂O₃, wherein Y is a tetravalent element and X is a trivalent element, wherein the zeolitic material has a YO₂ to X₂O₃ molar ratio of higher than 100 if the zeolitic material comprises X2O₃.

It is preferred that the zeolitic material comprised in the molding exhibits in the temperature programmed desorption of ammonia in the temperature range of from 100 to 500° C. an ammonia adsorption of equal to or smaller than 1.50 μmol/g, more preferably of equal to or smaller than 1.00 μmol/g, more preferably of equal to or smaller than 0.50 μmol/g, more preferably of equal to or smaller than 0.25 μmol/g, preferably determined according to Reference Example 4.

It is preferred that the molding comprises the zeolitic material in an amount in the range of from 0.05 to 9.0 weight-%, more preferably in the range of from 0.10 to 7.5 weight-%, more preferably in the range of from 0.10 to 5.0 weight-%, more preferably in the range of from 0.15 to 3.5 weight-%, more preferably in the range of from 0.15 to 2.0 weight-%, more preferably in the range of from 0.2 to 1.5 weight-%, more preferably in the range of from 0.2 to 1.0 weight-%, based on the total weight of the molding.

It is preferred that the zeolitic material comprised in the molding has a primary pore size of equal to or less than 1.2 nm, more preferably in the range of from 0.1 to 1.2 nm, more preferably in the range of from 0.5 to 1.0 nm, preferably determined according to Reference Example 7.

It is preferred that the tetravalent element Y comprised in the zeolitic material of the molding is selected from the group consisting of Si, Sn, Ti, Zr, Ge, and a mixture of two or more thereof, more preferably from the group consisting of Si, Ti, and a mixture of two or more thereof, wherein more preferably the tetravalent element Y is Si and/or Ti.

It is preferred that the trivalent element X comprised in the zeolitic material of the molding is selected from the group consisting of B, Al, Ga, In, and a mixture of two or more thereof, more preferably from the group consisting of B, Al, and a mixture of two or more thereof, wherein more preferably the tetravalent element Y is B and/or Al.

It is preferred that the zeolitic material comprised in the molding comprises the tetravalent element Y, O, and optionally the trivalent element X in its framework structure.

It is preferred that the zeolitic material comprised in the molding has a framework structure having a maximum ring size of equal to or more than 10 T-atoms, preferably a maximum ring size of 10 and/or 12 T-atoms.

It is preferred that from 95 to 100 weight-%, more preferably from 97 to 100 weight-%, more preferably from 99 to 100 weight-% of the zeolitic material comprised in the molding consists of Y, O, H, and optionally X.

It is preferred that the zeolitic material comprised in the molding has a framework structure type selected from the group consisting of BEA, FAU, MFI, MWW, GIS, MOR, LTA, FER, TON, MTT, MEL, MFS, and a mixed structure of two or more thereof, more preferably selected from the group consisting of BEA, FAU, MFI, MWW, and a mixed structure of two or more thereof, more preferably selected from the group consisting of BEA, MFI, FAU, and a mixed structure of two or more thereof, wherein more preferably the zeolitic material has a BEA- or MFI-type framework structure.

It is preferred that the zeolitic material comprised in the molding is selected from the group consisting of a TS-1 zeolite, a beta zeolite, a silicalite-1, and a mixture of two or more thereof, more preferably from the group consisting of a TS-1 zeolite, a hollow TS-1 zeolite, a silicalite-1, a boron-containing beta zeolite, an all-silica beta zeolite, and a mixture of two or more thereof.

It is preferred that the zeolitic material comprised in the molding has a YO₂ to X₂O₃ molar ratio of equal to or greater than 200, more preferably of equal to or greater than 300, more preferably of equal to or greater than 400, more preferably of equal to or greater than 500, more preferably in the range of from 500 to 1900, more preferably in the range of from 700 to 1500, more preferably in the range of from 900 to 1100, if the zeolitic material comprises X2O₃.

It is preferred that the zeolitic material comprised in the molding comprises equal to or less than 5.0 weight-% of X, more preferably equal to or less than 2.0 weight-% of X, more preferably equal to or less than 1.0 weight-% of X, more preferably equal to or less than 0.1 weight-% of X, more preferably equal to or less than 0.01 weight-% of X, more preferably equal to or less than 0.001 weight-% of X, based on 100 weight-% of Y, calculated as YO₂, in the zeolitic material.

It is preferred that the zeolitic material comprised in the molding exhibits in the temperature programmed desorption of tetrahydrofuran a peak having a maximum in the range of from 100 to 250° C., more preferably in the range of from 105 to 200° C., more preferably in the range of from 110 to 175° C., more preferably in the range of from 115 to 150° C., preferably determined according to Reference Example 2.

It is preferred that the zeolitic material comprised in the molding exhibits in the temperature programmed desorption of tetrahydrofuran one maximum, more preferably determined according to Reference Example 2.

It is preferred that the zeolitic material comprised in the molding exhibits in the temperature programmed desorption of tetrahydrofuran a tetrahydrofuran adsorption in the range of from 1800 to 2550 μmol/g, more preferably in the range of from 1850 to 2500 μmol/g, more preferably in the range of from 1900 to 2450 μmol/g, more preferably in the range of from 1950 to 2400 μmol/g, more preferably in the range of from 1980 to 2390 μmol/g, preferably determined according to Reference Example 2.

It is preferred that the zeolitic material comprised in the molding exhibits in the temperature programmed desorption of water a type IV isotherm, more preferably determined according to Reference Example 1.

It is preferred that the zeolitic material comprised in the molding exhibits a water adsorption in the range of from 1 to 35 weight-%, more preferably in the range of from 3 to 30 weight-%, more preferably in the range of from 5 to 28 weight-% preferably in the range of from 9 to 27 weight-%, more preferably in the range of from 11 to 26.5 weight-%, more preferably in the range of from 12 to 26 weight-%, and more preferably in the range of from 13 to 25.5 weight-%, when exposed to a relative humidity of 85%, wherein the water adsorption is preferably measured under isothermal conditions at 25° C., and wherein the water adsorption is preferably determined according to Reference Example 1.

It is preferred that the zeolitic material comprised in the molding has a BET specific surface area in the range of from 400 to 1100 m²/g, more preferably in the range of from 425 to 750 m²/g, more preferably in the range of from 450 to 600 m²/g, preferably determined according to Reference Example 3.

It is preferred that the zeolitic material comprised in the molding has a volume-based particle size D10 in the range of from 0.2 to 7.5, more preferably in the range of from 0.5 to 5.5 μm, more preferably in the range of from 0.75 to 3.5 μm, more preferably in the range of from 1.0 to 2.5 μm, preferably determined according to Reference Example 6.

It is preferred that the zeolitic material comprised in the molding has a volume-based particle size D50 in the range of from 0.5 to 25.0, more preferably in the range of from 1.0 to 20.0 μm, more preferably in the range of from 1.5 to 12.0 μm, more preferably in the range of from 2.0 to 6.0 μm, preferably determined according to Reference Example 6.

It is preferred that the zeolitic material comprised in the molding has a volume-based particle size D90 in the range of from 1.0 to 35.0 μm, more preferably in the range of from 2.0 to 25.0 μm, more preferably in the range of from 3.0 to 12.0 μm, more preferably in the range of from 3.5 to 9.0 μm, preferably determined according to Reference Example 6.

It is preferred that the molding comprises the poly(butylene dicarboxylate) polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the molding.

It is preferred that the dicarboxylate of the poly(butylene dicarboxylate) polyester comprised in the molding comprises, preferably consists of, one or more of adipate, terephthalate, sebacate, azelate, succinate, and 2,5-furandicarboxylate, more preferably one or more of adipate and terephthalate, more preferably adipate terephthalate or terephthalate.

It is preferred that the molding further comprises on or more of a poly(ethylene) terephthalate and a poly(propylene) terephthalate.

It is preferred that the molding comprises the one or more of a poly(ethylene) terephthalate and a poly(propylene) terephthalate in an amount in the range of from 30 to 100 weight-%, based on the total weight of the poly(butylene) terephthalate, more preferably in the range of from 50 to 100 weight-%, more preferably in the range of from 60 to 100 weight-%.

It is preferred that the poly(butylene dicarboxylate) polyester comprised in the molding has a viscosity number in the range of from 50 to 220, preferably in the range of from 80 to 160, preferably determined according to ISO 1628-5:1998.

It is preferred that the poly(butylene dicarboxylate) polyester comprised in the molding comprises an amount of terminal carboxy groups equal to or less than 100 meq/kg of poly(butylene dicarboxylate) polyester, more preferably equal to or less than 50 meq/kg of poly(butylene dicarboxylate) polyester, more preferably equal to or less than 40 meq/kg of poly(butylene dicarboxylate) polyester.

It is preferred that the poly(butylene dicarboxylate) polyester comprised in the molding comprises Ti in an amount of equal to or less than 250 ppm, more preferably equal to or less than 200 ppm, more preferably equal to or less than 150 ppm.

It is preferred that the poly(butylene dicarboxylate) polyester comprised in the molding comprises a blend of poly(butylene dicarboxylate) polyester and a further polyester, wherein the further polyester is more preferably a component of the repeating units of the poly(butylene) terephthalate, wherein the polyester is different to the poly(butylene dicarboxylate) polyester.

It is preferred that the poly(butylene dicarboxylate) polyester comprised in the molding comprises a fully aromatic polyester, more preferably a fully aromatic polyester of an aromatic dicarboxylic acid or a fully aromatic polyester of an aromatic dihydroxy compound.

In the case where the poly(butylene dicarboxylate) polyester comprised in the molding comprises a fully aromatic polyester, it is preferred that the poly(butylene dicarboxylate) polyester comprises from 2 to 80 weight-% of the fully aromatic polyester.

It is preferred that the poly(butylene dicarboxylate) polyester comprised in the molding comprises a polycarbonate, more preferably a halogen-free polycarbonate, more preferably a polycarbonate comprising a biphenol repeating unit.

In the case where the poly(butylene dicarboxylate) polyester comprised in the molding comprises a polycarbonate, it is preferred that the polycarbonate exhibits a relative viscosity nᵣₑₗ in the range of from 1.10 to 1.50, more preferably in the range of from 1.25 to 1.40.

Further in the case where the poly(butylene dicarboxylate) polyester comprised in the molding comprises a polycarbonate, it is preferred that the polycarbonate has an average molar mass M_{w} (weight average molar mass) in the range of from 10000 to 200000 g/mol, more preferably in the range of from 20000 to 80000 g/mol, preferably determined according to Reference Example 5.

It is preferred that the molding further comprises an acrylic acid polymer, more preferably in an amount in the range of from 0.01 to 2 weight-%, more preferably in the range of from 0.05 to 1.5 weight-%, more preferably in the range of from 0.1 to 1 weight-%, based on the total weight of the molding.

In the case where the molding further comprises an acrylic acid polymer, it is preferred that the acrylic acid polymer comprises acrylic acid units in an amount in the range of from 70 to 100 weight-%, more preferably in the range of from 85 to 100 weight-%, based on the total weight of the acrylic acid polymer, and wherein the acrylic acid polymer comprises an ethylenically unsaturated monomer different to acrylic acid, selected from the group consisting of monoethylenically unsaturated carboxylic acids, preferably in an amount in the range of from equal to or greater than 0 to 30 weight-%, more preferably in the range of from equal to or greater than 0 to 15 weight-%, wherein the monoethylenically unsaturated carboxylic acid comprises one or more of methacrylic acid, maleic acid, fumaric acid, itaconic acid, mesaconic acid, methylenemalonic acid, and citraconic acid.

Further in the case where the molding further comprises an acrylic acid polymer, it is preferred that the acrylic acid polymer has an average molar mass M_{w} (weight average molar mass) in the range of from 1000 to 100,000 g/mol, more preferably in the range of from 1000 to 12,000 g/mol, more preferably in the range of from 1,500 to 8,000 g/mol, more preferably in the range of from 3,500 to 6,500 g/mol, preferably determined according to Reference Example 5.

Further in the case where the molding further comprises an acrylic acid polymer, it is preferred that the acrylic acid polymer has a pH of equal to or less than 4, more preferably of equal to or less than 3.

It is preferred that the molding further comprises one or more additives, wherein the additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, more preferably from the group consisting of glass fibers, minerals, impact-modifiers, fluorine-containing ethylene polymers, and a mixture of two or more thereof.

In the case where the molding further comprises one or more additives, it is preferred that the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds more preferably comprise one or more of potassium hydroxide, calcium hydroxide, magnesium hydroxide, and magnesium carbonate.

Further in the case where the molding further comprises one or more additives, it is preferred that the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and a mixture of two or more thereof, wherein the polyol more preferably comprises one or more of sorbitol, xylitol, erythritol, threitol, and pentaerythritol, wherein the polyol more preferably comprises, more preferably consists of, pentaerythritol.

Further in the case where the molding further comprises one or more additives, it is preferred that the molding comprises the lubricants in an amount in the range of from 0.20 to 1.00 weight-%, more preferably in the range of from 0.35 to 0.70 weight-%, more preferably in the range of from 0.39 to 0.66 weight-%, based on the total weight of the molding.

Further in the case where the molding further comprises one or more additives, it is preferred that the glass fibers comprise one or more of glass wovens, glass mats, glass nonwovens, glass filament rovings, and chopped glass filaments made from low-alkali E glass, wherein the glass fibers preferably have a diameter in the range of from 5 to 200 micrometer, more preferably in the range of from 8 to 50 micrometer.

Further in the case where the molding further comprises one or more additives, it is preferred that the impact-modifiers comprise one or more of an ethylene-propylene elastomer, an ethylene-propylene-diene elastomer, and an emulsion polymer.

In the case where the impact-modifiers comprise one or more of an ethylene-propylene elastomer, an ethylene-propylene-diene elastomer, and an emulsion polymer, it is preferred that the respective elastomer is homogeneously structured and has a core-shell structure, wherein the core-shell structure preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

Further in the case where the impact-modifiers comprise one or more of an ethylene-propylene elastomer, an ethylene-propylene-diene elastomer, and an emulsion polymer, it is preferred that the emulsion polymer is selected from the group consisting of n-butyl acrylate-(meth)acrylic acid copolymers, n-butyl acrylateglycidyl acrylate copolymers or n-butyl acrylate-glycidyl methacrylate copolymers.

Further in the case where the molding further comprises one or more additives, it is preferred that the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, more preferably acicular wollastonite.

Further in the case where the molding further comprises one or more additives, it is preferred that the fluorine-containing ethylene polymers comprise a fluorine content in the range of from 55 to 76 weight-%, more preferably in the range of from 70 to76 weight-%, based on the total weight of the fluorine-containing ethylene polymers, wherein the fluorine-containing ethylene polymers preferably are one or more of polytetrafluoroethylene (PTFE), tetrafluoroethylene-hexafluoropropylene copolymers, and tetrafluoroethylene copolymers, wherein the molding preferably comprises the fluorine-containing ethylene polymers in an amount in the range of from equal to or greater than 0 to 2 weight-%, based on the total weight of the molding.

Further in the case where the molding further comprises one or more additives, it is preferred that the molding comprises the one or more additives in an amount in the range of from equal to or greater than 0 to 70 weight-%, based on the total weight of the molding, more preferably in the range of from 0.01 to 50 weight-%, more preferably in the range of from 0.1 to 30 weight-%, more preferably in the range of from 1 to 25 weight-%.

It is preferred that the molding is in the form of a powder, of a granule, or of an extrudate, wherein the extrudate is preferably a strand.

It is preferred that the molding has a total emission of volatile organic compounds of at most 50 ppm, more preferably of at most 20 ppm, more preferably of at most 15 ppm, more preferably of at most 10 ppm, preferably determined in accordance with VDA 277, more preferably in accordance with VDA 277 as disclosed in Example 13.

Further, the present invention relates to a process for preparing a molding comprising a poly(butylene) terephthalate and a zeolitic material, preferably for preparing a molding according to any one of the embodiments disclosed herein, the process comprising
(i) Preparing a mixture comprising a poly(butylene) terephthalate in an amount in the range of from equal to or greater than 10 to 99.99 weight-%, based on the total weight of the mixture, a zeolitic material in an amount of from 0.01 to 10 weight-%, based on the total weight of the mixture, and optionally one or more additives in an amount in the range of from equal to or greater than 0 to 70 weight-%, based on the total weight of the mixture,
(ii) Shaping the mixture obtained from (i),
   wherein the zeolitic material comprises YO₂ and optionally X₂O₃, wherein Y is a tetravalent element and X is a trivalent element, and wherein the zeolitic material has a YO₂ to X₂O₃ molar ratio of higher than 100 if the zeolitic material comprises X2O₃.

It is preferred that preparing the mixture according to (i) of the process is performed in a mixer.

It is preferred that preparing the mixture according to (i) of the process is performed at a temperature of the mixture in the range of from 225 to 300° C., more preferably in the range of from 230 to 280° C.

It is preferred that shaping according to (ii) of the process comprises extruding the mixture obtained from (i), more preferably with an extruder, more preferably a twin-screw-extruder.

It is preferred that the mixture is shaped in (ii) of the process to a powder, a granule, or an extrudate, wherein the extrudate is more preferably a strand.

It is preferred that the zeolitic material comprised in the mixture prepared in (i) of the process exhibits in the temperature programmed desorption of ammonia in the temperature range of from 100 to 500° C. an ammonia adsorption of equal to or smaller than 1.50 μmol/g, more preferably of equal to or smaller than 1.00 μmol/g, more preferably of equal to or smaller than 0.50 μmol/g, more preferably of equal to or smaller than 0.25 μmol/g, preferably determined according to Reference Example 4.

It is preferred that the mixture prepared in (i) of the process comprises the zeolitic material in an amount of from 0.05 to 9.0 weight-%, more preferably in the range of from 0.10 to 7.5 weight-%, more preferably in the range of from 0.10 to 5.0 weight-%, more preferably in the range of from 0.15 to 3.5 weight-%, more preferably in the range of from 0.15 to 2.0 weight-%, more preferably in the range of from 0.2 to 1.5 weight-%, more preferably in the range of from 0.2 to 1.0 weight-%, based on the total weight of the mixture.

It is preferred that the zeolitic material comprised in the mixture prepared in (i) of the process has a primary pore size of equal to or less than 1.2 nm, more preferably in the range of from 0.1 to 1.2 nm, more preferably in the range of from 0.5 to 1.0 nm, preferably determined according to Reference Example 7.

It is preferred that the tetravalent element Y comprised in the zeolitic material is selected from the group consisting of Si, Sn, Ti, Zr, Ge, and a mixture of two or more thereof, more preferably from the group consisting of Si, Ti, and a mixture of two or more thereof, wherein more preferably the tetravalent element Y is Si and/or Ti.

It is preferred that the trivalent element X comprised in the zeolitic material is selected from the group consisting of B, Al, Ga, In, and a mixture of two or more thereof, more preferably from the group consisting of B, Al, and a mixture of two or more thereof, wherein more preferably the tetravalent element Y is B and/or Al.

It is preferred that the zeolitic material comprised in the mixture prepared in (i) of the process comprises the tetravalent element Y, O, and optionally the trivalent element X in its framework structure.

It is preferred that the zeolitic material comprised in the mixture prepared in (i) of the process has a framework structure having a maximum ring size of equal to or more than 10 T-atoms, more preferably a maximum ring size of 10 and/or 12 T-atoms.

It is preferred that from 95 to 100 weight-%, more preferably from 97 to 100 weight-%, more preferably from 99 to 100 weight-% of the zeolitic material comprised in the mixture prepared in (i) of the process consists of Si, O, and H, wherein more preferably from 95 to 100 weight-%, more preferably from 97 to 100 weight-%, more preferably from 99 to 100 weight-% of the zeolitic material consists of Y, O, H, and optionally X.

It is preferred that the zeolitic material comprised in the mixture prepared in (i) of the process has a framework structure type selected from the group consisting of BEA, FAU, MFI, MWW, GIS, MOR, LTA, FER, TON, MTT, MEL, MFS, and a mixed structure of two or more thereof, more preferably selected from the group consisting of BEA, FAU, MFI, MWW, and a mixed structure of two or more thereof, more preferably selected from the group consisting of BEA, MFI, FAU, and a mixed structure of two or more thereof, wherein more preferably the zeolitic material has a BEA- or MFI-type framework structure.

It is preferred that the zeolitic material comprised in the mixture prepared in (i) of the process is selected from the group consisting of a TS-1 zeolite, a beta zeolite, a silicalite-1, and a mixture of two or more thereof, more preferably from the group consisting of a TS-1 zeolite, a hollow TS-1 zeolite, a silicalite-1, a boron-containing beta zeolite, an all-silica beta zeolite, and a mixture of two or more thereof.

It is preferred that the zeolitic material comprised in the mixture prepared in (i) of the process comprises X₂O₃ and has a YO₂ to X₂O₃ molar ratio of equal to or greater than 200, more preferably of equal to or greater than 300, more preferably of equal to or greater than 400, more preferably of equal to or greater than 500, more preferably in the range of from 500 to 1900, more preferably in the range of from 700 to 1500, more preferably in the range of from 900 to 1100.

It is preferred that the zeolitic material comprised in the mixture prepared in (i) of the process comprises equal to or less than 5.0 weight-% of X, more preferably equal to or less than 2.0 weight-% of X, more preferably equal to or less than 1.0 weight-% of X, more preferably equal to or less than 0.1 weight-% of X, more preferably equal to or less than 0.01 weight-% of X, more preferably equal to or less than 0.001 weight-% of X, based on 100 weight-% of Y, calculated as YO₂, in the zeolitic material.

It is preferred that the zeolitic material comprised in the mixture prepared in (i) of the process exhibits in the temperature programmed desorption of tetrahydrofuran a peak having a maximum in the range of from 100 to 250° C., more preferably in the range of from 105 to 200° C., more preferably in the range of from 110 to 175° C., more preferably in the range of from 115 to 150° C., preferably determined according to Reference Example 2.

It is preferred that the zeolitic material comprised in the mixture prepared in (i) of the process exhibits in the temperature programmed desorption of tetrahydrofuran one maximum, more preferably determined according to Reference Example 2.

It is preferred that the zeolitic material comprised in the mixture prepared in (i) of the process exhibits in the temperature programmed desorption of tetrahydrofuran a tetrahydrofuran adsorption in the range of from 1800 to 2550 μmol/g, more preferably in the range of from 1850 to 2500 μmol/g, more preferably in the range of from 1900 to 2450 μmol/g, more preferably in the range of from 1950 to 2400 μmol/g, more preferably in the range of from 1980 to 2390 μmol/g, preferably determined according to Reference Example 2.

It is preferred that the zeolitic material comprised in the mixture prepared in (i) of the process exhibits in the temperature programmed desorption of water a type IV isotherm, more preferably determined according to Reference Example 1.

It is preferred that the zeolitic material comprised in the mixture prepared in (i) of the process exhibits a water adsorption in the range of from 1 to 35 weight-%, more preferably in the range of from 3 to 30 weight-%, more preferably in the range of from 5 to 28 weight-% preferably in the range of from 9 to 27 weight-%, more preferably in the range of from 11 to 26.5 weight-%, more preferably in the range of from 12 to 26 weight-%, and more preferably in the range of from 13 to 25.5 weight-%, when exposed to a relative humidity of 85%, wherein the water adsorption is preferably measured under isothermal conditions at 25° C., and wherein the water adsorption is preferably determined according to Reference Example 1.

It is preferred that the zeolitic material comprised in the mixture prepared in (i) of the process has a BET specific surface area in the range of from 400 to 1100 m²/g, more preferably in the range of from 425 to 750 m²/g, more preferably in the range of from 450 to 600 m²/g, preferably determined according to Reference Example 3.

It is preferred that the zeolitic material comprised in the mixture prepared in (i) of the process has a volume-based particle size D10 in the range of from 0.2 to 7.5, more preferably in the range of from 0.5 to 5.5 μm, more preferably in the range of from 0.75 to 3.5 μm, more preferably in the range of from 1.0 to 2.5 μm, preferably determined according to Reference Example 6.

It is preferred that the zeolitic material comprised in the mixture prepared in (i) of the process has a volume-based particle size D50 in the range of from 0.5 to 25.0, more preferably in the range of from 1.0 to 20.0 μm, more preferably in the range of from 1.5 to 12.0 μm, more preferably in the range of from 2.0 to 6.0 μm, preferably determined according to Reference Example 6.

It is preferred that the zeolitic material comprised in the mixture prepared in (i) of the process has a volume-based particle size D90 in the range of from 1.0 to 35.0 μm, more preferably in the range of from 2.0 to 25.0 μm, more preferably in the range of from 3.0 to 12.0 μm, more preferably in the range of from 3.5 to 9.0 μm, preferably determined according to Reference Example 6.

It is preferred that the mixture prepared in (i) of the process comprises the poly(butylene dicarboxylate) polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the mixture.

It is preferred that the mixture prepared in (i) of the process further comprises on or more of a poly(ethylene) terephthalate, and a poly(propylene) terephthalate.

In the case where the mixture prepared in (i) of the process further comprises on or more of a poly(ethylene) terephthalate, and a poly(propylene) terephthalate, it is preferred that the mixture prepared in (i) of the process comprises the one or more of a poly(ethylene) terephthalate and a poly(propylene) terephthalate in an amount in the range of from 30 to 100 weight-%, based on the total weight of the poly(butylene dicarboxylate) polyester, more preferably in the range of from 50 to 100 weight-%, more preferably in the range of from 60 to 100 weight-%.

It is preferred that the poly(butylene dicarboxylate) polyester comprised in the mixture prepared in (i) of the process has a viscosity number in the range of from 50 to 220, more preferably in the range of from 80 to 160, preferably determined according to ISO 1628-5:1998.

It is preferred that the poly(butylene dicarboxylate) polyester comprised in the mixture prepared in (i) of the process comprises an amount of terminal carboxy groups equal to or less than 100 meq/kg of poly(butylene dicarboxylate) polyester, more preferably equal to or less than 50 meq/kg of poly(butylene dicarboxylate) polyester, more preferably equal to or less than 40 meq/kg of poly(butylene dicarboxylate) polyester.

It is preferred that the poly(butylene dicarboxylate) polyester comprised in the mixture prepared in (i) of the process comprises Ti in an amount of equal to or less than 250 ppm, more preferably equal to or less than 200 ppm, more preferably equal to or less than 150 ppm.

It is preferred that the poly(butylene dicarboxylate) polyester comprised in the mixture prepared in (i) of the process comprises a blend of the poly(butylene dicarboxylate) polyester and a further polyester, wherein the further polyester is more preferably a component of the repeating units of the poly(butylene dicarboxylate) polyester, wherein the further polyester is different to the poly(butylene dicarboxylate) polyester.

In the case where the poly(butylene dicarboxylate) polyester comprised in the mixture prepared in (i) of the process comprises a blend of the poly(butylene dicarboxylate) polyester and a further polyester, it is preferred that the poly(butylene dicarboxylate) polyester comprises a fully aromatic polyester, more preferably a fully aromatic polyester of an aromatic dicarboxylic acid or a fully aromatic polyester of an aromatic dihydroxy compound.

In the case where the poly(butylene dicarboxylate) polyester comprises a fully aromatic polyester, it is preferred that the poly(butylene dicarboxylate) polyester comprises from 2 to 80 weight-% of the fully aromatic polyester.

It is preferred that the polyester comprised in the mixture prepared in (i) of the process comprises a polycarbonate, more preferably a halogen-free polycarbonate, more preferably a polycarbonate comprising a biphenol repeating unit.

In the case where the polyester comprised in the mixture prepared in (i) of the process comprises a polycarbonate, it is preferred that the polycarbonate exhibits a relative viscosity nᵣₑₗ in the range of from 1.10 to 1.50, more preferably in the range of from 1.25 to 1.40.

Further in the case where the polyester comprised in the mixture prepared in (i) of the process comprises a polycarbonate, it is preferred that the polycarbonate has an average molar mass M_{w} (weight average molar mass) in the range of from 10000 to 200000 g/mol, preferably in the range of from 20000 to 80000 g/mol, preferably determined according to Reference Example 5.

It is prepared that the mixture prepared in (i) of the process comprises an acrylic acid polymer, more preferably in an amount in the range of from 0.01 to 2 weight-%, more preferably in the range of from 0.05 to 1.5 weight-%, more preferably in the range of from 0.1 to 1 weight-%, based on the total weight of the mixture.

In the case where the mixture prepared in (i) of the process comprises an acrylic acid polymer, it is preferred that the acrylic acid polymer comprises acrylic acid units in an amount in the range of from 70 to 100 weight-%, more preferably in the range of from 85 to 100 weight-%, based on the total weight of the acrylic acid polymer, and it is further preferred that the acrylic acid polymer comprises an ethylenically unsaturated monomer different to acrylic acid, selected from the group consisting of monoethylenically unsaturated carboxylic acids, more preferably in an amount in the range of from equal to or greater than 0 to 30 weight-%, more preferably in the range of from equal to or greater than 0 to 15 weight-%, wherein the monoethylenically unsaturated carboxylic acid comprises one or more of methacrylic acid, maleic acid, fumaric acid, itaconic acid, mesaconic acid, methylenemalonic acid, and citraconic acid.

Further in the case where the mixture prepared in (i) of the process comprises an acrylic acid polymer, it is preferred that the acrylic acid polymer has an average molar mass M_{w} (weight average molar mass) in the range of from 1000 to 100000 g/mol, more preferably in the range of from 1000 to 12000 g/mol, more preferably in the range of from 1500 to 8000 g/mol, more preferably in the range of from 3500 to 6500 g/mol, preferably determined according to Reference Example 5.

Further in the case where the mixture prepared in (i) of the process comprises an acrylic acid polymer, it is preferred that the acrylic acid polymer has a pH of equal to or less than 4, more preferably of equal to or less than 3.

It is preferred that the mixture prepared in (i) of the process comprises the one or more additives, wherein the additives are more preferably selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, more preferably from the group consisting of glass fibers, minerals, impact-modifiers, fluorine-containing ethylene polymers, and a mixture of two or more thereof.

In the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and ammixture of two or more thereof, wherein the polyol more preferably comprises one or more of sorbitol, xylitol, erythritol, threitol, and pentaerythritol, wherein the polyol more preferably comprises, more preferably consists of, pentaerythritol.

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the mixture prepared in (i) of the process comprises the lubricants in an amount in the range of from 0.20 to 1.00 weight-%, more preferably in the range of from 0.35 to 0.70 weight-%, more preferably in the range of from 0.39 to 0.66 weight-%, based on the total weight of the mixture prepared in (i).

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the glass fibers comprise one or more of glass wovens, glass mats, glass nonwovens, glass filament rovings, and chopped glass filaments made from low-alkali E glass, wherein the glass fibers more preferably have a diameter in the range of from 5 to 200 micrometer, more preferably in the range of from 8 to 50 micrometer.

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the impact-modifiers comprise one or more of an ethylene-propylene elastomer, an ethylene-propylene-diene elastomer, and an emulsion polymer.

In the case where the impact-modifiers comprise one or more of an ethylene-propylene elastomer, an ethylene-propylene-diene elastomer, and an emulsion polymer, it is preferred that the respective elastomer is homogeneously structured and has a core-shell structure, wherein the core-shell structure preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

Further in the case where the impact-modifiers comprise one or more of an ethylene-propylene elastomer, an ethylene-propylene-diene elastomer, and an emulsion polymer, it is preferred that the emulsion polymer is selected from the group consisting of n-butyl acrylate-(meth)acrylic acid copolymers, n-butyl acrylateglycidyl acrylate or n-butyl acrylate-glycidyl methacrylate copolymers.

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, more preferably acicular wollastonite.

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the one or more additives comprise the fluorine-containing ethylene polymers, more preferably a fluorine-containing ethylene polymer comprising a fluorine content in the range of from 55 to 76 weight-%, more preferably in the range of from 70 to 76 weight-%, based on the total weight of the fluorine-containing ethylene polymer, wherein the fluorine-containing ethylene polymers preferably are one or more of polytetrafluoroethylene (PTFE), tetrafluoroethylene-hexafluoropropylene copolymers, and tetrafluoroethylene copolymers, wherein the mixture prepared in (i) preferably comprises the fluorine-containing ethylene polymers in an amount in the range of from equal to or greater than 0 to 2 weight-%, based on the total weight of the mixture.

Further in the case where the mixture prepared in (i) of the process comprises the one or more additives selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, it is preferred that the mixture prepared in (i) of the process comprises the one or more additives in an amount in the range of from 0.01 to 50 weight-%, based on the total weight of the mixture, more preferably in the range of from 0.1 to 30 weight-%, more preferably in the range of from 1 to 25 weight-%.

Yet further, the present invention relates to a molding comprising a poly(butylene dicarboxylate) polyester and a zeolitic material, wherein the molding is obtainable and/or obtained by a process according to any one of the embodiments disclosed herein.

Yet further, the present invention relates to a use of a molding according to any one of the embodiments disclosed herein, as packaging, preferably as packaging for one or more of a food, a cosmetic, and a pharmaceutical, more preferably as packaging for one or more of skin cream, hair-care products, dental care products, medicaments, coffee, convenience food, meat, jam, a milk product, as a component for kitchen devices, preferably as a component being in contact with drinking water, or as a component for a car, preferably as a component for the interior of a motor-vehicle.

Yet further, the present invention relates to a use of a molding according to any one of the embodiments disclosed herein, for the preparation of a fiber, a film, or a molding having a shape different from the molding according to any one of the embodiments disclosed herein, preferably for the preparation of a capsule.

According to the present invention, a zeolitic material can be understood as a material with pores, in particular of pores of uniform size. Typically, the pores have diameters similar to the size of small molecules. Thus, large molecules cannot enter or be adsorbed, while smaller molecules can. It is recommended according to a panel of the IUPAC to designate materials having a pore diameter of less than 2 nm (20 Å) as microporous, materials having a pore diameter of greater than 50 nm (500 Å) as macroporous, and materials having a pore diameter between 2 and 50 nm (20-500 Å) as mesoporous.

According to the present invention, an impact-modifier can be a polymer, preferably a rubber or an elastomer.

In particular with respect to the preparation of further components to be used for the preparation of the molding of the present invention reference is made to EP 3004242 B1 disclosing suitable further components. Thus, EP 3004242 B1 is incorporated herein in its entirety.

In particular with respect to the additives which may be comprised in the molding of the present invention, reference is made to US 2003/195296 A1 disclosing suitable additives. Thus, US 2003/195296 A1 is incorporated herein in its entirety.

The unit bar (abs) refers to an absolute pressure wherein 1 bar equals 10⁵ Pa and the unit Angstrom (Å) refers to a length of 10⁻¹⁰ m.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”.

Further, it is explicitly noted that the following set of embodiments is not the set of claims determining the extent of protection, but represents a suitably structured part of the description directed to general and preferred aspects of the present invention.

According to an embodiment (1), the present invention relates to a molding comprising,
(i) a poly(butylene dicarboxylate) polyester in an amount in the range of from equal to or greater than 10 to 99.99 weight-%, based on the total weight of the molding,
(ii) a zeolitic material in an amount of from 0.01 to 10 weight-%, based on the total weight of the molding,
   wherein the zeolitic material comprises YO₂ and optionally X₂O₃, wherein Y is a tetravalent element and X is a trivalent element, wherein the zeolitic material has a YO₂ to X₂O₃ molar ratio of higher than 100 if the zeolitic material comprises X₂O₃.

A preferred embodiment (2) concretizing embodiment (1) relates to said molding, wherein the zeolitic material exhibits in the temperature programmed desorption of ammonia in the temperature range of from 100 to 500° C. an ammonia adsorption of equal to or smaller than 1.50 μmol/g, preferably of equal to or smaller than 1.00 μmol/g, more preferably of equal to or smaller than 0.50 μmol/g, more preferably of equal to or smaller than 0.25 μmol/g, preferably determined according to Reference Example 4.

A preferred embodiment (3) concretizing embodiment (1) or (2) relates to said molding, wherein the molding comprises the zeolitic material in an amount in the range of from 0.05 to 9.0 weight-%, preferably in the range of from 0.10 to 7.5 weight-%, more preferably in the range of from 0.10 to 5.0 weight-%, more preferably in the range of from 0.15 to 3.5 weight-%, more preferably in the range of from 0.15 to 2.0 weight-%, more preferably in the range of from 0.2 to 1.5 weight-%, more preferably in the range of from 0.2 to 1.0 weight-%, based on the total weight of the molding.

A preferred embodiment (4) concretizing any one of embodiments (1) to (3) relates to said molding, wherein the zeolitic material has a primary pore size of equal to or less than 1.2 nm, preferably in the range of from 0.1 to 1.2 nm, more preferably in the range of from 0.5 to 1.0 nm, preferably determined according to Reference Example 7.

A preferred embodiment (5) concretizing any one of embodiments (1) to (4) relates to said molding, wherein the tetravalent element Y is selected from the group consisting of Si, Sn, Ti, Zr, Ge, and a mixture of two or more thereof, preferably from the group consisting of Si, Ti, and a mixture of two or more thereof, wherein more preferably the tetravalent element Y is Si and/or Ti.

A preferred embodiment (6) concretizing any one of embodiments (1) to (5) relates to said molding, wherein the trivalent element X is selected from the group consisting of B, Al, Ga, In, and a mixture of two or more thereof, preferably from the group consisting of B, Al, and a mixture of two or more thereof, wherein more preferably the tetravalent element Y is B and/or Al.

A preferred embodiment (7) concretizing any one of embodiments (1) to (6) relates to said molding, wherein the zeolitic material comprises the tetravalent element Y, O, and optionally the trivalent element X in its framework structure.

A preferred embodiment (8) concretizing any one of embodiments (1) to (7) relates to said molding, wherein the zeolitic material has a framework structure having a maximum ring size of equal to or more than 10 T-atoms, preferably a maximum ring size of 10 and/or 12 T-atoms.

A preferred embodiment (9) concretizing any one of embodiments (1) to (8) relates to said molding, wherein from 95 to 100 weight-%, preferably from 97 to 100 weight-%, more preferably from 99 to 100 weight-% of the zeolitic material consists of Y, O, H, and optionally X.

A preferred embodiment (10) concretizing any one of embodiments (1) to (9) relates to said molding, wherein the zeolitic material has a framework structure type selected from the group consisting of BEA, FAU, MFI, MWW, GIS, MOR, LTA, FER, TON, MTT, MEL, MFS, and a mixed structure of two or more thereof, preferably selected from the group consisting of BEA, FAU, MFI, MWW, and a mixed structure of two or more thereof, more preferably selected from the group consisting of BEA, MFI, FAU, and a mixed structure of two or more thereof, wherein more preferably the zeolitic material has a BEA- or MFI-type framework structure.

A preferred embodiment (11) concretizing any one of embodiments (1) to (10) relates to said molding, wherein the zeolitic material is selected from the group consisting of a TS-1 zeolite, a beta zeolite, a silicalite-1, and a mixture of two or more thereof, preferably from the group consisting of a TS-1 zeolite, a hollow TS-1 zeolite, a silicalite-1, a boron-containing beta zeolite, an all-silica beta zeolite, and a mixture of two or more thereof.

A preferred embodiment (12) concretizing any one of embodiments (1) to (11) relates to said molding, wherein the zeolitic material has a YO₂ to X₂O₃ molar ratio of equal to or greater than 200, preferably of equal to or greater than 300, more preferably of equal to or greater than 400, more preferably of equal to or greater than 500, more preferably in the range of from 500 to 1900, more preferably in the range of from 700 to 1500, more preferably in the range of from 900 to 1100, if the zeolitic material comprises X₂O₃.

A preferred embodiment (13) concretizing any one of embodiments (1) to (12) relates to said molding, wherein the zeolitic material comprises equal to or less than 5.0 weight-% of X, preferably equal to or less than 2.0 weight-% of X, more preferably equal to or less than 1.0 weight-% of X, more preferably equal to or less than 0.1 weight-% of X, more preferably equal to or less than 0.01 weight-% of X, more preferably equal to or less than 0.001 weight-% of X, based on 100 weight-% of Y, calculated as YO₂, in the zeolitic material.

A preferred embodiment (14) concretizing any one of embodiments (1) to (13) relates to said molding, wherein the zeolitic material exhibits in the temperature programmed desorption of tetrahydrofuran a peak having a maximum in the range of from 100 to 250° C., preferably in the range of from 105 to 200° C., more preferably in the range of from 110 to 175° C., more preferably in the range of from 115 to 150° C., preferably determined according to Reference Example 2.

A preferred embodiment (15) concretizing any one of embodiments (1) to (14) relates to said molding, wherein the zeolitic material exhibits in the temperature programmed desorption of tetrahydrofuran one maximum, preferably determined according to Reference Example 2.

A preferred embodiment (16) concretizing any one of embodiments (1) to (15) relates to said molding, wherein the zeolitic material exhibits in the temperature programmed desorption of tetrahydrofuran a tetrahydrofuran adsorption in the range of from 1800 to 2550 μmol/g, preferably in the range of from 1850 to 2500 μmol/g, more preferably in the range of from 1900 to 2450 μmol/g, more preferably in the range of from 1950 to 2400 μmol/g, more preferably in the range of from 1980 to 2390 μmol/g, preferably determined according to Reference Example 2.

A preferred embodiment (17) concretizing any one of embodiments (1) to (16) relates to said molding, wherein the zeolitic material exhibits in the temperature programmed desorption of water a type IV isotherm, preferably determined according to Reference Example 1.

A preferred embodiment (18) concretizing any one of embodiments (1) to (17) relates to said molding, wherein the zeolitic material exhibits a water adsorption in the range of from 1 to 35 weight-%, preferably in the range of from 3 to 30 weight-%, more preferably in the range of from 5 to 28 weight-% preferably in the range of from 9 to 27 weight-%, more preferably in the range of from 11 to 26.5 weight-%, more preferably in the range of from 12 to 26 weight-%, and more preferably in the range of from 13 to 25.5 weight-%, when exposed to a relative humidity of 85%, wherein the water adsorption is preferably measured under isothermal conditions at 25° C., and wherein the water adsorption is preferably determined according to Reference Example 1.

A preferred embodiment (19) concretizing any one of embodiments (1) to (18) relates to said molding, wherein the zeolitic material has a BET specific surface area in the range of from 400 to 1100 m²/g, preferably in the range of from 425 to 750 m²/g, more preferably in the range of from 450 to 600 m²/g, preferably determined according to Reference Example 3.

A preferred embodiment (20) concretizing any one of embodiments (1) to (19) relates to said molding, wherein the zeolitic material has a volume-based particle size D10 in the range of from 0.2 to 7.5, preferably in the range of from 0.5 to 5.5 μm, more preferably in the range of from 0.75 to 3.5 μm, more preferably in the range of from 1.0 to 2.5 μm, preferably determined according to Reference Example 6.

A preferred embodiment (21) concretizing any one of embodiments (1) to (20) relates to said molding, wherein the zeolitic material has a volume-based particle size D50 in the range of from 0.5 to 25.0, preferably in the range of from 1.0 to 20.0 μm, more preferably in the range of from 1.5 to 12.0 μm, more preferably in the range of from 2.0 to 6.0 μm, preferably determined according to Reference Example 6.

A preferred embodiment (22) concretizing any one of embodiments (1) to (21) relates to said molding, wherein the zeolitic material has a volume-based particle size D90 in the range of from 1.0 to 35.0 μm, preferably in the range of from 2.0 to 25.0 μm, more preferably in the range of from 3.0 to 12.0 μm, more preferably in the range of from 3.5 to 9.0 μm, preferably determined according to Reference Example 6.

A preferred embodiment (23) concretizing any one of embodiments (1) to (22) relates to said molding, wherein the molding comprises the poly(butylene dicarboxylate) polyester in an amount in the range of from 30 to 99.0 weight-%, preferably in the range of from 32.5 to 97.5 weight-%, more preferably in the range of from 32.5 to 95 weight-%, more preferably in the range of from 35 to 85 weight-%, based on the total weight of the molding.

A preferred embodiment (24) concretizing any one of embodiments (1) to (23) relates to said molding, wherein the dicarboxylate of the poly(butylene dicarboxylate) polyester comprises, preferably consists of, one or more of adipate, terephthalate, sebacate, azelate, succinate, and 2,5-furandicarboxylate, preferably one or more of adipate and terephthalate, more preferably adipate terephthalate or terephthalate.

A preferred embodiment (25) concretizing any one of embodiments (1) to (24) relates to said molding, wherein the molding further comprises on or more of a poly(ethylene) terephthalate and a poly(propylene) terephthalate.

A preferred embodiment (26) concretizing any one of embodiments (1) to (25) relates to said molding, wherein the molding comprises the one or more of a poly(ethylene) terephthalate and a poly(propylene) terephthalate in an amount in the range of from 30 to 100 weight-%, based on the total weight of the poly(butylene) terephthalate, preferably in the range of from 50 to 100 weight-%, more preferably in the range of from 60 to 100 weight-%.

A preferred embodiment (27) concretizing any one of embodiments (1) to (26) relates to said molding, wherein the poly(butylene dicarboxylate) polyester has a viscosity number in the range of from 50 to 220, preferably in the range of from 80 to 160, preferably determined according to ISO 1628-5:1998.

A preferred embodiment (28) concretizing any one of embodiments (1) to (27) relates to said molding, wherein the poly(butylene dicarboxylate) polyester comprises an amount of terminal carboxy groups equal to or less than 100 meq/kg of poly(butylene dicarboxylate) polyester, preferably equal to or less than 50 meq/kg of poly(butylene dicarboxylate) polyester, more preferably equal to or less than 40 meq/kg of poly(butylene dicarboxylate) polyester.

A preferred embodiment (29) concretizing any one of embodiments (1) to (28) relates to said molding, wherein the poly(butylene dicarboxylate) polyester comprises Ti in an amount of equal to or less than 250 ppm, preferably equal to or less than 200 ppm, more preferably equal to or less than 150 ppm.

A preferred embodiment (30) concretizing any one of embodiments (1) to (29) relates to said molding, wherein the poly(butylene dicarboxylate) polyester comprises a blend of poly(butylene dicarboxylate) polyester and a further polyester, wherein the further polyester is preferably a component of the repeating units of the poly(butylene) terephthalate, wherein the polyester is different to the poly(butylene dicarboxylate) polyester.

A preferred embodiment (31) concretizing any one of embodiments (1) to (30) relates to said molding, wherein the poly(butylene dicarboxylate) polyester comprises a fully aromatic polyester, preferably a fully aromatic polyester of an aromatic dicarboxylic acid or a fully aromatic polyester of an aromatic dihydroxy compound.

A preferred embodiment (32) concretizing embodiment (31) relates to said molding, wherein the poly(butylene dicarboxylate) polyester comprises from 2 to 80 weight-% of the fully aromatic polyester.

A preferred embodiment (33) concretizing any one of embodiments (1) to (32) relates to said molding, wherein the poly(butylene dicarboxylate) polyester comprises a polycarbonate, preferably a halogen-free polycarbonate, more preferably a polycarbonate comprising a biphenol repeating unit.

A preferred embodiment (34) concretizing embodiment (33) relates to said molding, wherein the polycarbonate exhibits a relative viscosity nᵣₑₗ in the range of from 1.10 to 1.50, preferably in the range of from 1.25 to 1.40.

A preferred embodiment (35) concretizing embodiment (33) or (34) relates to said molding, wherein the polycarbonate has an average molar mass M_{w} (weight average molar mass) in the range of from 10000 to 200000 g/mol, preferably in the range of from 20000 to 80000 g/mol, preferably determined according to Reference Example 5.

A preferred embodiment (36) concretizing any one of embodiments (1) to (35) relates to said molding, wherein the molding further comprises an acrylic acid polymer, preferably in an amount in the range of from 0.01 to 2 weight-%, more preferably in the range of from 0.05 to 1.5 weight-%, more preferably in the range of from 0.1 to 1 weight-%, based on the total weight of the molding.

A preferred embodiment (37) concretizing embodiment (36) relates to said molding, wherein the acrylic acid polymer comprises acrylic acid units in an amount in the range of from 70 to 100 weight-%, preferably in the range of from 85 to 100 weight-%, based on the total weight of the acrylic acid polymer, and wherein the acrylic acid polymer comprises an ethylenically unsaturated monomer different to acrylic acid, selected from the group consisting of monoethylenically unsaturated carboxylic acids, preferably in an amount in the range of from equal to or greater than 0 to 30 weight-%, more preferably in the range of from equal to or greater than 0 to 15 weight-%, wherein the monoethylenically unsaturated carboxylic acid comprises one or more of methacrylic acid, maleic acid, fumaric acid, itaconic acid, mesaconic acid, methylenemalonic acid, and citraconic acid.

A preferred embodiment (38) concretizing embodiment (36) or (37) relates to said molding, wherein the acrylic acid polymer has an average molar mass M_{w} (weight average molar mass) in the range of from 1000 to 100,000 g/mol, preferably in the range of from 1000 to 12,000 g/mol, more preferably in the range of from 1,500 to 8,000 g/mol, more preferably in the range of from 3,500 to 6,500 g/mol, preferably determined according to Reference Example 5.

A preferred embodiment (39) concretizing any one of embodiments (36) to (38) relates to said molding, wherein the acrylic acid polymer has a pH of equal to or less than 4, preferably of equal to or less than 3.

A preferred embodiment (40) concretizing any one of embodiments (1) to (39) relates to said molding, wherein the molding further comprises one or more additives, wherein the additives are selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, preferably from the group consisting of glass fibers, minerals, impact-modifiers, fluorine-containing ethylene polymers, and a mixture of two or more thereof.

A preferred embodiment (41) concretizing embodiment (40) relates to said molding, wherein the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

A preferred embodiment (42) concretizing embodiment (40) or (41) relates to said molding, wherein the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and a mixture of two or more thereof, wherein the polyol more preferably comprises one or more of sorbitol, xylitol, erythritol, threitol, and pentaerythritol, wherein the polyol more preferably comprises, more preferably consists of, pentaerythritol.

A preferred embodiment (43) concretizing any one of embodiments (40) to (42) relates to said molding, wherein the molding comprises the lubricants in an amount in the range of from 0.20 to 1.00 weight-%, preferably in the range of from 0.35 to 0.70 weight-%, more preferably in the range of from 0.39 to 0.66 weight-%, based on the total weight of the molding.

A preferred embodiment (44) concretizing any one of embodiments (40) to (43) relates to said molding, wherein the glass fibers comprise one or more of glass wovens, glass mats, glass nonwovens, glass filament rovings, and chopped glass filaments made from low-alkali E glass, wherein the glass fibers preferably have a diameter in the range of from 5 to 200 micrometer, more preferably in the range of from 8 to 50 micrometer.

A preferred embodiment (45) concretizing any one of embodiments (40) to (44) relates to said molding, wherein the impact-modifiers comprise one or more of an ethylene-propylene elastomer, an ethylene-propylene-diene elastomer, and an emulsion polymer.

A preferred embodiment (46) concretizing embodiment (45) relates to said molding, wherein the elastomer is homogeneously structured and has a core-shell structure, wherein the core-shell structure preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

A preferred embodiment (47) concretizing embodiment (45) or (46) relates to said molding, wherein the emulsion polymer is selected from the group consisting of n-butyl acrylate-(meth)acrylic acid copolymers, n-butyl acrylateglycidyl acrylate copolymers or n-butyl acrylate-glycidyl methacrylate copolymers.

A preferred embodiment (48) concretizing any one of embodiments (40) to (47) relates to said molding, wherein the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, preferably acicular wollastonite.

A preferred embodiment (49) concretizing any one of embodiments (40) to (48) relates to said molding, wherein the fluorine-containing ethylene polymers comprise a fluorine content in the range of from 55 to 76 weight-%, preferably in the range of from 70 to76 weight-%, based on the total weight of the fluorine-containing ethylene polymers, wherein the fluorine-containing ethylene polymers preferably are one or more of polytetrafluoroethylene (PTFE), tetrafluoroethylene-hexafluoropropylene copolymers, and tetrafluoroethylene copolymers, wherein the molding preferably comprises the fluorine-containing ethylene polymers in an amount in the range of from equal to or greater than 0 to 2 weight-%, based on the total weight of the molding.

A preferred embodiment (50) concretizing any one of embodiments (40) to (49) relates to said molding, wherein the molding comprises the one or more additives in an amount in the range of from equal to or greater than 0 to 70 weight-%, based on the total weight of the molding, preferably in the range of from 0.01 to 50 weight-%, more preferably in the range of from 0.1 to 30 weight-%, more preferably in the range of from 1 to 25 weight-%.

A preferred embodiment (51) concretizing any one of embodiments (1) to (50) relates to said molding, wherein the molding is in the form of a powder, of a granule, or of an extrudate, wherein the extrudate is preferably a strand.

A preferred embodiment (52) concretizing any one of embodiments (1) to (51) relates to said molding, wherein the molding has a total emission of volatile organic compounds of at most 50 ppm, preferably of at most 20 ppm, more preferably of at most 15 ppm, more preferably of at most 10 ppm, preferably determined in accordance with VDA 277, more preferably in accordance with VDA 277 as disclosed in Example 13.

An embodiment (53) of the present invention relates to a process for preparing a molding comprising a poly(butylene) terephthalate and a zeolitic material, preferably for preparing a molding according to any one of embodiments (1) to (52), the process comprising
(i) Preparing a mixture comprising a poly(butylene) terephthalate in an amount in the range of from equal to or greater than 10 to 99.99 weight-%, based on the total weight of the mixture, a zeolitic material in an amount of from 0.01 to 10 weight-%, based on the total weight of the mixture, and optionally one or more additives in an amount in the range of from greater than 0 to 70 weight-%, based on the total weight of the mixture,
(ii) Shaping the mixture obtained from (i),
wherein the zeolitic material comprises YO₂ and optionally X₂O₃, wherein Y is a tetravalent element and X is a trivalent element, and wherein the zeolitic material has a YO₂ to X₂O₃ molar ratio of higher than 100 if the zeolitic material comprises X₂O₃.

A preferred embodiment (54) concretizing embodiment (53) relates to said process, wherein preparing the mixture according to (i) is performed in a mixer.

A preferred embodiment (55) concretizing embodiment (53) or (54) relates to said process, wherein preparing the mixture according to (i) is performed at a temperature of the mixture in the range of from 225 to 300° C., preferably in the range of from 230 to 280° C.

A preferred embodiment (56) concretizing any one of embodiments (53) to (55) relates to said process, wherein shaping according to (ii) comprises extruding the mixture obtained from (i), preferably with an extruder, more preferably a twin-screw-extruder.

A preferred embodiment (57) concretizing any one of embodiments (53) to (56) relates to said process, wherein the mixture is shaped in (ii) to a powder, a granule, or an extrudate, wherein the extrudate is preferably a strand.

A preferred embodiment (58) concretizing any one of embodiments (53) to (57) relates to said process, wherein the zeolitic material exhibits in the temperature programmed desorption of ammonia in the temperature range of from 100 to 500° C. an ammonia adsorption of equal to or smaller than 1.50 μmol/g, preferably of equal to or smaller than 1.00 μmol/g, more preferably of equal to or smaller than 0.50 μmol/g, more preferably of equal to or smaller than 0.25 μmol/g, preferably determined according to Reference Example 4.

A preferred embodiment (59) concretizing any one of embodiments (53) to (58) relates to said process, wherein the mixture prepared in (i) comprises the zeolitic material in an amount of from 0.05 to 9.0 weight-%, preferably in the range of from 0.10 to 7.5 weight-%, more preferably in the range of from 0.10 to 5.0 weight-%, more preferably in the range of from 0.15 to 3.5 weight-%, more preferably in the range of from 0.15 to 2.0 weight-%, more preferably in the range of from 0.2 to 1.5 weight-%, more preferably in the range of from 0.2 to 1.0 weight-%, based on the total weight of the mixture.

A preferred embodiment (60) concretizing any one of embodiments (53) to (59) relates to said process, wherein the zeolitic material has a primary pore size of equal to or less than 1.2 nm, preferably in the range of from 0.1 to 1.2 nm, more preferably in the range of from 0.5 to 1.0 nm, preferably determined according to Reference Example 7.

A preferred embodiment (61) concretizing any one of embodiments (53) to (60) relates to said process, wherein the tetravalent element Y is selected from the group consisting of Si, Sn, Ti, Zr, Ge, and a mixture of two or more thereof, preferably from the group consisting of Si, Ti, and a mixture of two or more thereof, wherein more preferably the tetravalent element Y is Si and/or Ti.

A preferred embodiment (62) concretizing any one of embodiments (53) to (61) relates to said process, wherein the trivalent element X is selected from the group consisting of B, Al, Ga, In, and a mixture of two or more thereof, preferably from the group consisting of B, Al, and a mixture of two or more thereof, wherein more preferably the tetravalent element Y is B and/or Al.

A preferred embodiment (63) concretizing any one of embodiments (53) to (62) relates to said process, wherein the zeolitic material comprises the tetravalent element Y, O, and optionally the trivalent element X in its framework structure.

A preferred embodiment (64) concretizing any one of embodiments (53) to (63) relates to said process, wherein the zeolitic material has a framework structure having a maximum ring size of equal to or more than 10 T-atoms, preferably a maximum ring size of 10 and/or 12 T-atoms.

A preferred embodiment (65) concretizing any one of embodiments (53) to (64) relates to said process, wherein from 95 to 100 weight-%, preferably from 97 to 100 weight-%, more preferably from 99 to 100 weight-% of the zeolitic material consists of Si, O, and H, wherein more preferably from 95 to 100 weight-%, more preferably from 97 to 100 weight-%, more preferably from 99 to 100 weight-% of the zeolitic material consists of Y, O, H, and optionally X.

A preferred embodiment (66) concretizing any one of embodiments (53) to (65) relates to said process, wherein the zeolitic material has a framework structure type selected from the group consisting of BEA, FAU, MFI, MWW, GIS, MOR, LTA, FER, TON, MTT, MEL, MFS, and a mixed structure of two or more thereof, preferably selected from the group consisting of BEA, FAU, MFI, MWW, and a mixed structure of two or more thereof, more preferably selected from the group consisting of BEA, MFI, FAU, and a mixed structure of two or more thereof, wherein more preferably the zeolitic material has a BEA- or MFI-type framework structure.

A preferred embodiment (67) concretizing any one of embodiments (53) to (66) relates to said process, wherein the zeolitic material is selected from the group consisting of a TS-1 zeolite, a beta zeolite, a silicalite-1, and a mixture of two or more thereof, preferably from the group consisting of a TS-1 zeolite, a hollow TS-1 zeolite, a silicalite-1, a boron-containing beta zeolite, an all-silica beta zeolite, and a mixture of two or more thereof.

A preferred embodiment (68) concretizing any one of embodiments (53) to (67) relates to said process, wherein the zeolitic material has a YO₂ to X₂O₃ molar ratio of equal to or greater than 200, more preferably of equal to or greater than 300, more preferably of equal to or greater than 400, more preferably of equal to or greater than 500, more preferably in the range of from 500 to 1900, more preferably in the range of from 700 to 1500, more preferably in the range of from 900 to 1100.

A preferred embodiment (69) concretizing any one of embodiments (53) to (68) relates to said process, wherein the zeolitic material comprises equal to or less than 5.0 weight-% of X, preferably equal to or less than 2.0 weight-% of X, more preferably equal to or less than 1.0 weight-% of X, more preferably equal to or less than 0.1 weight-% of X, more preferably equal to or less than 0.01 weight-% of X, more preferably equal to or less than 0.001 weight-% of X, based on 100 weight-% of Y, calculated as YO₂, in the zeolitic material.

A preferred embodiment (70) concretizing any one of embodiments (53) to (69) relates to said process, wherein the zeolitic material exhibits in the temperature programmed desorption of tetrahydrofuran a peak having a maximum in the range of from 100 to 250° C., preferably in the range of from 105 to 200° C., more preferably in the range of from 110 to 175° C., more preferably in the range of from 115 to 150° C., preferably determined according to Reference Example 2.

A preferred embodiment (71) concretizing any one of embodiments (53) to (70) relates to said process, wherein the zeolitic material exhibits in the temperature programmed desorption of tetrahydrofuran one maximum, preferably determined according to Reference Example 2.

A preferred embodiment (72) concretizing any one of embodiments (53) to (71) relates to said process, wherein the zeolitic material exhibits in the temperature programmed desorption of tetrahydrofuran a tetrahydrofuran adsorption in the range of from 1800 to 2550 μmol/g, preferably in the range of from 1850 to 2500 μmol/g, more preferably in the range of from 1900 to 2450 μmol/g, more preferably in the range of from 1950 to 2400 μmol/g, more preferably in the range of from 1980 to 2390 μmol/g, preferably determined according to Reference Example 2.

A preferred embodiment (73) concretizing any one of embodiments (53) to (72) relates to said process, wherein the zeolitic material exhibits in the temperature programmed desorption of water a type IV isotherm, preferably determined according to Reference Example 1.

A preferred embodiment (74) concretizing any one of embodiments (53) to (73) relates to said process, wherein the zeolitic material exhibits a water adsorption in the range of from 1 to 35 weight-%, preferably in the range of from 3 to 30 weight-%, more preferably in the range of from 5 to 28 weight-% preferably in the range of from 9 to 27 weight-%, more preferably in the range of from 11 to 26.5 weight-%, more preferably in the range of from 12 to 26 weight-%, and more preferably in the range of from 13 to 25.5 weight-%, when exposed to a relative humidity of 85%, wherein the water adsorption is preferably measured under isothermal conditions at 25° C., and wherein the water adsorption is preferably determined according to Reference Example 1.

A preferred embodiment (75) concretizing any one of embodiments (53) to (74) relates to said process, wherein the zeolitic material has a BET specific surface area in the range of from 400 to 1100 m²/g, preferably in the range of from 425 to 750 m²/g, more preferably in the range of from 450 to 600 m²/g, preferably determined according to Reference Example 3.

A preferred embodiment (76) concretizing any one of embodiments (53) to (75) relates to said process, wherein the zeolitic material has a volume-based particle size D10 in the range of from 0.2 to 7.5, preferably in the range of from 0.5 to 5.5 μm, more preferably in the range of from 0.75 to 3.5 μm, more preferably in the range of from 1.0 to 2.5 μm, preferably determined according to Reference Example 6.

A preferred embodiment (77) concretizing any one of embodiments (53) to (76) relates to said process, wherein the zeolitic material has a volume-based particle size D50 in the range of from 0.5 to 25.0, preferably in the range of from 1.0 to 20.0 μm, more preferably in the range of from 1.5 to 12.0 μm, more preferably in the range of from 2.0 to 6.0 μm, preferably determined according to Reference Example 6.

A preferred embodiment (78) concretizing any one of embodiments (53) to (77) relates to said process, wherein the zeolitic material has a volume-based particle size D90 in the range of from 1.0 to 35.0 μm, preferably in the range of from 2.0 to 25.0 μm, more preferably in the range of from 3.0 to 12.0 μm, more preferably in the range of from 3.5 to 9.0 μm, preferably determined according to Reference Example 6.

A preferred embodiment (79) concretizing any one of embodiments (53) to (78) relates to said process, wherein the mixture prepared in (i) comprises the poly(butylene dicarboxylate) polyester in an amount in the range of from 30 to 99.0 weight-%, more preferably in the range of from 32.5 to 97.5 weight-%, more preferably in the range of from 32.5 to 95 weight-%, more preferably in the range of from 35 to 85 weight-%, based on the total weight of the mixture.

A preferred embodiment (80) concretizing any one of embodiments (53) to (79) relates to said process, wherein the mixture prepared in (i) further comprises on or more of a poly(ethylene) terephthalate, and a poly(propylene) terephthalate.

A preferred embodiment (81) concretizing embodiment (80) relates to said process, wherein the mixture prepared in (i) comprises the one or more of a poly(ethylene) terephthalate and a poly(propylene) terephthalate in an amount in the range of from 30 to 100 weight-%, based on the total weight of the poly(butylene dicarboxylate) polyester, preferably in the range of from 50 to 100 weight-%, more preferably in the range of from 60 to 100 weight-%.

A preferred embodiment (82) concretizing any one of embodiments (53) to (81) relates to said process, wherein the poly(butylene dicarboxylate) polyester has a viscosity number in the range of from 50 to 220, preferably in the range of from 80 to 160, preferably determined according to ISO 1628-5:1998.

A preferred embodiment (83) concretizing any one of embodiments (53) to (82) relates to said process, wherein the poly(butylene dicarboxylate) polyester comprises an amount of terminal carboxy groups equal to or less than 100 meq/kg of poly(butylene dicarboxylate) polyester, preferably equal to or less than 50 meq/kg of poly(butylene dicarboxylate) polyester, more preferably equal to or less than 40 meq/kg of poly(butylene dicarboxylate) polyester.

A preferred embodiment (84) concretizing any one of embodiments (53) to (83) relates to said process, wherein the poly(butylene dicarboxylate) polyester comprises Ti in an amount of equal to or less than 250 ppm, preferably equal to or less than 200 ppm, more preferably equal to or less than 150 ppm.

A preferred embodiment (85) concretizing any one of embodiments (53) to (84) relates to said process, wherein the poly(butylene dicarboxylate) polyester comprises a blend of the poly(butylene dicarboxylate) polyester and a further polyester, wherein the further polyester is preferably a component of the repeating units of the poly(butylene dicarboxylate) polyester, wherein the further polyester is different to the poly(butylene dicarboxylate) polyester.

A preferred embodiment (86) concretizing embodiment (85) relates to said process, wherein the poly(butylene dicarboxylate) polyester comprises a fully aromatic polyester, preferably a fully aromatic polyester of an aromatic dicarboxylic acid or a fully aromatic polyester of an aromatic dihydroxy compound.

A preferred embodiment (87) concretizing embodiment (86) relates to said process, wherein the poly(butylene dicarboxylate) polyester comprises from 2 to 80 weight-% of the fully aromatic polyester.

A preferred embodiment (88) concretizing any one of embodiments (53) to (87) relates to said process, wherein the polyester comprises a polycarbonate, preferably a halogen-free polycarbonate, more preferably a polycarbonate comprising a biphenol repeating unit.

A preferred embodiment (89) concretizing embodiment (88) relates to said process, wherein the polycarbonate exhibits a relative viscosity nᵣₑₗ in the range of from 1.10 to 1.50, preferably in the range of from 1.25 to 1.40.

A preferred embodiment (90) concretizing embodiment (88) or (89) relates to said process, wherein the polycarbonate has an average molar mass M_{w} (weight average molar mass) in the range of from 10000 to 200000 g/mol, preferably in the range of from 20000 to 80000 g/mol, preferably determined according to Reference Example 5.

A preferred embodiment (91) concretizing any one of embodiments (53) to (90) relates to said process, wherein the mixture prepared in (i) comprises an acrylic acid polymer, preferably in an amount in the range of from 0.01 to 2 weight-%, more preferably in the range of from 0.05 to 1.5 weight-%, more preferably in the range of from 0.1 to 1 weight-%, based on the total weight of the mixture.

A preferred embodiment (92) concretizing embodiment (91) relates to said process, wherein the acrylic acid polymer comprises acrylic acid units in an amount in the range of from 70 to 100 weight-%, preferably in the range of from 85 to 100 weight-%, based on the total weight of the acrylic acid polymer, and wherein the acrylic acid polymer comprises an ethylenically unsaturated monomer different to acrylic acid, selected from the group consisting of monoethylenically unsaturated carboxylic acids, preferably in an amount in the range of from equal to or greater than 0 to 30 weight-%, more preferably in the range of from equal to or greater than 0 to 15 weight-%, wherein the monoethylenically unsaturated carboxylic acid comprises one or more of methacrylic acid, maleic acid, fumaric acid, itaconic acid, mesaconic acid, methylenemalonic acid, and citraconic acid.

A preferred embodiment (93) concretizing embodiment (90) or (91) relates to said process, wherein the acrylic acid polymer has an average molar mass M_{w} (weight average molar mass) in the range of from 1000 to 100000 g/mol, preferably in the range of from 1000 to 12000 g/mol, more preferably in the range of from 1500 to 8000 g/mol, more preferably in the range of from 3500 to 6500 g/mol, preferably determined according to Reference Example 5.

A preferred embodiment (94) concretizing any one of embodiments (90) to (93) relates to said process, wherein the acrylic acid polymer has a pH of equal to or less than 4, preferably of equal to or less than 3.

A preferred embodiment (95) concretizing any one of embodiments (53) to (94) relates to said process, wherein the mixture prepared in (i) comprises the one or more additives, wherein the additives are preferably selected from the group consisting of antioxidants, glass fibers, minerals, impact-modifiers, pigments, stabilizers, fillers, oxidation retarders, decomposition counteracting agents, lubricants, mold-release agents, colorants, plasticizers, fluorine-containing ethylene polymers, and a mixture thereof, more preferably from the group consisting of glass fibers, minerals, impact-modifiers, fluorine-containing ethylene polymers, and a mixture of two or more thereof.

A preferred embodiment (96) concretizing embodiment (95) relates to said process, wherein the stabilizers comprise one or more of alkoxymethylmelamines, amino-substituted triazines, sterically hindered phenols, metal-containing compounds, alkaline earth metal silicates, alkaline earth metal glycerophosphates, polyamides, sterically hindered amines, wherein the metal-containing compounds preferably comprise one or more of potassium hydroxide, calcium hydroxide, magnesium hydroxide, and magnesium carbonate.

A preferred embodiment (97) concretizing embodiment (95) or (96) relates to said process, wherein the lubricants comprise an ester of a fatty acid and a polyol, wherein the fatty acid is preferably an unsaturated fatty acid or a saturated fatty acid, wherein the saturated fatty acid is preferably selected from the group consisting of caprylic acid, capric acid, lauric acid, stearic acid, arachidic acid, behenic acid, lignoceric acid, cerotic acid, and a mixture of two or more thereof, wherein the saturated fatty acid more preferably comprises, more preferably consists of, stearic acid, wherein the unsaturated fatty acid is preferably selected from the group consisting of myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and a mixture of two or more thereof, wherein the polyol is preferably selected from the group of triols, tetrols, pentols, hexols, and ammixture of two or more thereof, wherein the polyol more preferably comprises one or more of sorbitol, xylitol, erythritol, threitol, and pentaerythritol, wherein the polyol more preferably comprises, more preferably consists of, pentaerythritol.

A preferred embodiment (98) concretizing any one of embodiments (95) to (97) relates to said process, wherein the mixture prepared in (i) comprises the lubricants in an amount in the range of from 0.20 to 1.00 weight-%, preferably in the range of from 0.35 to 0.70 weight-%, more preferably in the range of from 0.39 to 0.66 weight-%, based on the total weight of the mixture prepared in (i).

A preferred embodiment (99) concretizing any one of embodiments (95) to (98) relates to said process, wherein the glass fibers comprise one or more of glass wovens, glass mats, glass nonwovens, glass filament rovings, and chopped glass filaments made from low-alkali E glass, wherein the glass fibers preferably have a diameter in the range of from 5 to 200 micrometer, more preferably in the range of from 8 to 50 micrometer.

A preferred embodiment (100) concretizing any one of embodiments (95) to (99) relates to said process, wherein the impact-modifiers comprise one or more of an ethylene-propylene elastomer, an ethylene-propylene-diene elastomer, and an emulsion polymer.

A preferred embodiment (101) concretizing embodiment (100) relates to said process, wherein the elastomer is homogeneously structured and has a core-shell structure, wherein the core-shell structure preferably comprises a unit of one or more of 1,3-butadiene, isoprene, n-butyl acrylate, ethylhexyl acrylate, styrene acrylonitrile, and methyl methacrylate, for the core, and wherein the core-shell structure preferably comprises a unit of one or more of styrene acrylonitrile, methyl methacrylate, n-butyl acrylate, ethyl acrylate, methyl acrylate, 1,3-butadiene, isoprene, and ethylhexyl acrylate, for the shell.

A preferred embodiment (102) concretizing embodiment (100) or (101) relates to said process, wherein the emulsion polymer is selected from the group consisting of n-butyl acrylate-(meth)acrylic acid copolymers, n-butyl acrylateglycidyl acrylate or n-butyl acrylate-glycidyl methacrylate copolymers.

A preferred embodiment (103) concretizing any one of embodiments (95) to (102) relates to said process, wherein the fillers comprise one or more of carbon black, glass fibers, glass beads, amorphous silica, asbestos, calcium silicate, calcium metasilicate, magnesium carbonate, kaolin, chalk, powdered quartz, mica, barium sulfate, feldspar, aramid fibers, potassium titanate fibers, and acicular mineral fillers, more preferably acicular wollastonite.

A preferred embodiment (104) concretizing any one of embodiments (95) to (103) relates to said process, wherein the one or more additives comprise the fluorine-containing ethylene polymers, preferably a fluorine-containing ethylene polymer comprising a fluorine content in the range of from 55 to 76 weight-%, more preferably in the range of from 70 to 76 weight-%, based on the total weight of the fluorine-containing ethylene polymer, wherein the fluorine-containing ethylene polymers preferably are one or more of polytetrafluoroethylene (PTFE), tetrafluoroethylene-hexafluoropropylene copolymers, and tetrafluoroethylene copolymers, wherein the mixture prepared in (i) preferably comprises the fluorine-containing ethylene polymers in an amount in the range of from equal to or greater than 0 to 2 weight-%, based on the total weight of the mixture.

A preferred embodiment (105) concretizing any one of embodiments (95) to (104) relates to said process, wherein the mixture prepared in (i) comprises the one or more additives in an amount in the range of from 0.01 to 50 weight-%, based on the total weight of the mixture, preferably in the range of from 0.1 to 30 weight-%, more preferably in the range of from 1 to 25 weight-%.

An embodiment (106) of the present invention relates to a molding comprising a poly(butylene dicarboxylate) polyester and a zeolitic material, wherein the molding is obtainable and/or obtained by a process according to any one of embodiments (53) to (105).

An embodiment (107) of the present invention relates to a use of a molding according to any one of embodiments (1) to (52) and (106), as packaging, preferably as packaging for one or more of a food, a cosmetic, and a pharmaceutical, more preferably as packaging for one or more of skin cream, hair-care products, dental care products, medicaments, coffee, convenience food, meat, jam, a milk product, as a component for kitchen devices, preferably as a component being in contact with drinking water, or as a component for a car, preferably as a component for the interior of a motor-vehicle.

An embodiment (108) of the present invention relates to a use of a molding according to any one of embodiments (1) to (52) and (106), for the preparation of a fiber, a film, or a molding having a shape different from the molding according to any one of embodiments (1) to (52) and (106), preferably for the preparation of a capsule.

The present invention is further illustrated by the following examples and reference examples.

### EXAMPLES

### Reference Example 1: Determination of Water Adsorption/Desorption Isotherm

Calculation of the water adsorption properties of the examples of the experimental section was performed on a VTI SA instrument from TA Instruments following a step-isotherm program. The experiment consisted of a run or a series of runs performed on a sample material that has been placed on the microbalance pan inside of the instrument. Before the measurement were started, the residual moisture of the sample was removed by heating the sample to 120° C. (heating ramp of 5° C./min) and holding it for 6 h under a N₂ flow. After the drying program, the temperature in the cell was decreased to 25° C. and kept isothermal during the measurements. The microbalance was calibrated, and the weight of the dried sample was balanced (maximum mass deviation 0.01 weight-%). Water uptake by the sample was measured as the increase in weight over that of the dry sample. First, an adsorption curve was measured by increasing the relative humidity (RH) (expressed as weight-% water in the atmosphere inside of the cell) to which the samples was exposed and measuring the water uptake by the sample at equilibrium. The RH was increased with a step of 10 weight-% from 5 to 85% and at each step the system controlled the RH and monitored the sample weight until reaching the equilibrium conditions and recording the weight uptake. The total adsorbed water amount by the sample was taken after the sample was exposed to the 85 weight-% RH. During the desorption measurement the RH was decreased from 85 weight-% to 5 weight-% with a step of 10% and the change in the weight of the samples (water uptake) was monitored and recorded.

### Reference Example 2: Determination of Temperature Programmed Desorption of THF (THF-TPD)

The temperature-programmed desorption of ammonia (THF-TPD) was conducted in an automated chemisorption analysis unit (Micromeritics AutoChem II 2920) having a thermal conductivity detector. The sample (<0.1 g) was introduced into a quartz tube and analysed using the program described below. The temperature was measured by means of a Ni/Cr/Ni thermocouple immediately above the sample in the quartz tube. For the analyses, He of purity 6.0 was used. Before any measurement, a blank sample was analysed for calibration.
1. Preparation: Commencement of recording; one measurement per 5 second. Wait for 10 minutes at 25° C. and a He flow rate of 50 cm³/min (room temperature (about 25° C.) and 1 atm); heat up to 250° C. at a heating rate of 10 K/min; hold for 60 minutes. Cool down under a He flow (50 cm³/min) to 40° C. at a cooling rate of 20 K/min (sample ramp temperature).
2. Saturation with THF with pulse chemisorption repeated 20 times at 40° C.
3. THF-TPD: Commencement of recording; one measurement per second. Heat up under a He flow (flow rate: 50 cm³/min) to 400° C. at a heating rate of 10 K/min; hold for 15 minutes.
4. End of measurement.

The amount of THF adsorbed (mmol/g of sample) was ascertained by means of the Micromeritics software through integration of the TPD signal with a horizontal baseline.

### Reference Example 3: Determination of the BET Specific Surface Area, the Langmuir Specific Surface Area, the Micropore Volume, the Average Pore Width and the Average Pore Diameter (N₂)

The BET specific surface area, the Langmuir specific surface area, the micropore volume, the average pore width and the average pore diameter (N₂) were determined via nitrogen physisorption at 77 K according to the method disclosed in DIN 66131.

### Reference Example 4: Determination of Temperature Programmed Desorption of Ammonia (NH₃-TPD)

The temperature-programmed desorption of ammonia (NH₃-TPD) was conducted in an automated chemisorption analysis unit (Micromeritics AutoChem II 2920) having a thermal conductivity detector. Continuous analysis of the desorbed species was accomplished using an online mass spectrometer (OmniStar QMG200 from Pfeiffer Vacuum). The sample (0.1 g) was introduced into a quartz tube and analyzed using the program described below. The temperature was measured by means of a Ni/Cr/Ni thermocouple immediately above the sample in the quartz tube. For the analyses, He of purity 5.0 was used. Before any measurement, a blank sample was analyzed for calibration.
1. Preparation: Commencement of recording; one measurement per second. Wait for 10 minutes at 25° C. and a He flow rate of 30 cm³/min (room temperature (about 25° C.) and 1 atm); heat up to 600° C. at a heating rate of 20 K/min; hold for 10 minutes. Cool down under a He flow (30 cm³/min) to 100° C. at a cooling rate of 20 K/min (furnace ramp temperature); Cool down under a He flow (30 cm³/min) to 100° C. at a cooling rate of 3 K/min (sample ramp temperature).
2. Saturation with NH₃: Commencement of recording; one measurement per second. Change the gas flow to a mixture of 10% NH₃ in He (75 cm³/min; 100° C. and 1 atm) at 100° C.; hold for 30 minutes.
3. Removal of the excess: Commencement of recording; one measurement per second. Change the gas flow to a He flow of 75 cm³/min (100° C. and 1 atm) at 100° C.; hold for 60 min.
4. NH₃-TPD: Commencement of recording; one measurement per second. Heat up under a He flow (flow rate: 30 cm³/min) to 600° C. at a heating rate of 10 K/min; hold for 30 minutes.
5. End of measurement.

Desorbed ammonia was measured by means of the online mass spectrometer, which demonstrates that the signal from the thermal conductivity detector was caused by desorbed ammonia. This involved utilizing the m/z=16 signal from ammonia in order to monitor the desorption of the ammonia. The amount of ammonia adsorbed (mmol/g of sample) was ascertained by means of the Micromeritics software through integration of the TPD signal with a horizontal baseline.

### Reference Example 5: Determination of the Molecular Weight of a Polymer

Molar masses of employed polyesters and polymers were determined by means of GPC. The GPC conditions used were as follows: 2 columns (Suprema Linear M) and one pre-column (Suprema pre-column), all using Suprema Gel (HEMA) products from Polymer Standard Services (Mainz, Germany), were operated at 35° C. with flow rate 0.8 ml/min. Eluent used comprised the aqueous solution buffered at pH 7 by TRIS, admixed with 0.15M NaCl and 0.01M NaN₃. Calibration was achieved with a Na-PAA standard of which the cumulative molar mass distribution curve had been determined by combined SEC/laser light scattering, by the calibration method of M. J. R. Cantow et al. (J. Polym. Sci., A-1.5 (1967) 1391-1394), but without the concentration correction proposed in that reference. All of the specimens were adjusted to pH 7 with 50% by weight aqueous sodium hydroxide solution. A portion of the solution was diluted with deionized water to 1.5 mg/ml solids content and stirred for 12 hours. The specimens were then filtered, and 100 μl were injected through a Sartorius Minisart RC (0.2 μm).

### Reference Example 6: Determination of the Particle-Size Distribution

The average particle size distribution was determined with a Mastersizer 2000 (Version 5.12G) from Malvern Panalytical. A sample was dispersed in water and the resulting dispersion subjected to ultrasound for 2 minutes.

The following parameters were set:
focal width: 300RF mm
beam length: 10.00 mm
module: MS17
shadowing: 16.9%
dispersion model: Hydro 2000S (A)
analysis model: universal
correction: none

### Reference Example 7: Determination of the Primary Pore Size

The determination of the primary pore size is well-stablished for every zeolite framework according to the data disclosed by International Zeolite Association (IZA) (see

https://europe.iza-structure.org/IZA-SC/ftc_table.php).

With respect to the determination of the porosity, reference is particularly made to ISO 15901-2:2006 for the determination of the total pore volume and of the adsorption average pore width (4V/A), to ISO 15901-3:2007 for the determination of the micropore volume, and to DIN 66134:1998-02 for the determination of the desorption average pore diameter (4V/A).

### Reference Example 8: Preparation of a Zeolite Beta (Si-Beta Zeolite)

A zeolite having framework structure type BEA was prepared in accordance with Example 6.2 of WO 2013/117537 A1.

The resulting zeolitic material had a volume-based particle size distribution characterized by a D10 value of 1.1 μm, a D50 value of 2.1 μm, and a D90 value of 4.0 μm, determined according to Reference Example 6. Further, the resulting zeolitic material exhibited a water adsorption of 20.5 weight-% when exposed to a relative humidity of 85%, determined according to Reference Example 1. In addition, it exhibited a concentration of acid sites of 0.132 mmol/g in the temperature range of from 100 to 500° C., wherein two maxima were observed, a first maximum at 173° C. and a second maximum at 480° C., determined according to Reference Example 4. In the temperature programmed desorption of water the resulting zeolitic material exhibited a type IV isotherm, determined according to Reference Example 1.

### Examples 1-12 and Comparative Examples 0-8: Preparation of Compositions Comprising a Poly(butylene) Terephthalate and a Zeolitic Material

As starting materials, a poly(butylene) terephthalate (PBT, Ultradur® B1950 NAT. of BASF company) with a melt-volume flow-rate (MVR) of 110 cm³/g 10 min. (in accordance with ISO 1133 for 250° C./2.16 kg), and a poly(butylene) terephthalate (PBT, B2550 NAT. of BASF company) with a melt-volume flow-rate (MVR) of 45 cm³/g 10 min. (in accordance with ISO 1133 for 250° C./2.16 kg) were used.

Further, a polyacrylic acid with average molar mass (Mw) of 5000 g/mol (by GPC) in the form of 49% aqueous solution (Sokalan® PA 25 XS from BASF SE) having a pH of 2, and glass fibers (glass fibers suitable for PBT; 3B company) were used. As a lubricant, a mixture of C16-C18 fatty acid esters of pentaerythritol were used.

For the examples in accordance with the present invention, a titanium silicalite-1 (TS-1) was prepared in accordance with WO 2011/064191 A1, a Si-MFI zeolite was obtained from China Catalyst Group (silicalite-1, Product code: CCG19Z02, SiO2 99.97) and a Si-MFI zeolite was obtained from Clariant (TCP9024), a ZSM-5 zeolite (Zeoflair 100) was obtained from Zeochem, a B-Beta zeolite prepared according to Example 6.1 of WO 2013/117537 A1, a Si-Beta zeolite was obtained from TWRD (Si-Beta TWRD), a Si-Beta zeolite (Si-Beta BASF) was prepared as outlined in Reference Example 8 in accordance with Example 6.2 of WO 2013/117537 A1.

For Comparative Examples 1-8 three different zeolite Y (having a SAR of 80, 30, 60; CBV780, CBV720, and CBV760, respectively; all purchased from Zeolyst), an ammonium zeolite Y (CBV712 from Zeolyst having a SAR of 12), a sodium zeolite Y (CBV100 from Zeolyst having a SAR of 5.1) and a sodium A zeolite (molecular sieve 13X having a SAR of 2.5; Alfa Aesar company; in accordance with U.S. Pat. No. 4,061,662) were used. An overview of the characteristics of the used materials can be found in table 1.

TABLE 1
Overview of characteristics of materials used in the examples and comparative examples.

| | | | | | Volume-based |
|---|---|---|---|---|---|
| | | | | | Particle size |
| | | SAR | Water | NH₃-TPD | distribution |
| | Zeolitic | (where | uptake | (Tₘₐₓ in ° C.; | D10/D50/D90 |
| # | material | applicable) | (weight-%) | mmol/g) | [μm] |
| For Example(s) | | | | | |
| 1 | TS-1 | >1000 | 8.9 | 165; 0.033 | 4.6/18.7/30.3 |
| | | | | 304; 0.030 | |
| 2 | B-beta | >1000 | 25.1 | | 2.2/10.1/14.1 |
| 3, 9, 12 | Si-beta | >1000 | 20.5 | 173; 0.040 | 1.1/2.1/4.0 |
| | (BASF) | | | 480; 0.092 | |
| 4, 7, 10 | Si-MFI | >1000 | 9.7 | | 1.6/3.0/4.7 |
| | (silicalite-1) | | | | |
| 5 | ZSM-5 | 400 | 6 | | 3.0/5.7/8.7 |
| | (Zeoflair 100) | | | | |
| 6, 11 | Si-MFI | >1000 | 8.5 | | 1.2/3.7/8.9 |
| | (TCP9024) | | | | |
| 8 | Si-Beta | >1000 | 13.0 | | 1.4/4.0/10.2 |
| | (TWRD) | | | | |
| For Comparative | | | | | |
| Example | | | | | |
| 1 | NaA | 2.5 | 28.7 | 192; 0.841 | |
| | | | | 272; 1.379 | |
| 2 | Y (H-form) | 80 | 34.6 | 167; 0.038 | |
| | | | | 330; 0.136 | |
| | | | | 566; 0.111 | |
| 3 | Y (H-form) | 30 | 33.3 | 191; 0.183 | 1.3/3.0/5.9 |
| | | | | 347; 0.447 | |
| | | | | 528; 0.090 | |
| 4 | Y (H-form) | 60 | 34.8 | 174; 0.070 | 1.1/2.4/6.2 |
| | | | | 347; 0.202 | |
| | | | | 535; 0.098 | |
| 5 | NH₄Y | 12 | 30.9 | 198; 0.384 | 1.5/4.1/9.0 |
| | | | | 354; 0.608 | |
| 6 | NaY | 5.1 | 28.9 | 207; 0.855 | 1.4/4.0/10.2 |

A zeolitic material was used, such that the resulting molding comprised 1 or 2 weight-% of the zeolitic material based on the total weight of the molding. Thus, Examples in accordance with the present invention were prepared as well as Comparative Examples using the starting materials and amounts thereof as noted in tables 2 and 3, whereby Comparative Examples 0 and 7 were prepared without using a zeolitic material, Comparative Example 8 was prepared using glass fibers (average diameter of 10 micrometer with epoxysilane sizing) to obtain a composition including 30 weight-% of glass fibers and 0.4 weight-% of carbon black (25% Printex 60 in B4500).

TABLE 2
Overview of amounts of starting materials used for comparative examples
(Comparative Examples 0 to 6).

| | Comp. | Comp. | Comp. | Comp. | Comp. | Comp. | Comp. |
|---|---|---|---|---|---|---|---|
| | Ex. 0 | Ex. 1 | Ex. 2 | Ex. 3 | Ex. 4 | Ex. 5 | Ex. 6 |
| Poly(butylene) tereph- | 98.8 | 97.8 | 97.8 | 97.8 | 97.8 | 97.8 | 97.8 |
| thalate (Ultradur B1950 | | | | | | | |
| NAT.) | | | | | | | |
| Lubricant (C16-C18 fatty | 0.65 | 0.65 | 0.65 | 0.65 | 0.65 | 0.65 | 0.65 |
| esters of pentaerythritol) | | | | | | | |
| Polyacrylic acid | 0.55 | 0.55 | 0.55 | 0.55 | 0.55 | 0.55 | 0.55 |
| Molecular sieve 13X | — | 1 | — | — | — | — | — |
| CBV780 | — | — | 1 | — | — | — | — |
| CBV720 | — | — | — | 1 | — | — | — |
| CBV760 | — | — | — | — | 1 | — | — |
| CBV712 | — | — | — | — | — | 1 | — |
| CBV100 | — | — | — | — | — | — | 1 |

TABLE 3
Overview of amounts of starting materials used for Examples 1-7 in
accordance with the present invention (Examples 1 to 7).

| | Ex. 1 | Ex. 2 | Ex. 3 | Ex. 4 | Ex. 5 | Ex. 6 | Ex. 7 |
|---|---|---|---|---|---|---|---|
| Poly(butylene) | 97.8 | 97.8 | 97.8 | 97.8 | 97.8 | 97.8 | 96.8 |
| terephthalate | | | | | | | |
| (Ultradur B1950 | | | | | | | |
| NAT.) | | | | | | | |
| Lubricant (C16-C18 | 0.65 | 0.65 | 0.65 | 0.65 | 0.65 | 0.65 | 0.65 |
| fatty esters of | | | | | | | |
| pentaerythritol) | | | | | | | |
| Polyacrylic acid | 0.55 | 0.55 | 0.55 | 0.55 | 0.55 | 0.55 | 0.55 |
| Titanium silicalite-1 | 1 | — | — | — | — | — | — |
| B-Beta | — | 1 | — | — | — | — | — |
| Si-Beta (BASF) | — | — | 1 | — | — | — | — |
| Si-MFI (Silicalite-1) | — | — | — | 1 | — | — | 2 |
| ZSM-5 (Zeoflair 100) | — | — | — | — | 1 | — | — |
| Si-MFI (TCP9024) | — | — | — | — | — | 1 | — |

TABLE 4
Overview of Comparative Example 7-8 and Examples 9-12 in
accordance with the present invention (Examples 9 to 12).

| | C7 | C8 | E8 | E9 | E10 | E11 | E12 |
|---|---|---|---|---|---|---|---|
| Poly(butylene) terephthalate (Ultradur | 98.8 | — | 97.8 | 97.8 | 97.8 | 97.8 | — |
| B1950 NAT) | | | | | | | |
| Poly(butylene) terephthalate (Ultradur | — | 69.2 | — | — | — | — | 67.4 |
| B2550 NAT) | | | | | | | |
| Lubricant (C16-C18 fatty esters of | 0.65 | 0.4 | 0.65 | 0.65 | 0.65 | 0.65 | 0.4 |
| pentaerythritol) | | | | | | | |
| Polyacrylic acid | 0.55 | — | 0.55 | 0.55 | 0.55 | 0.55 | 0.8 |
| Glass fiber (average diameter of 10 | — | 30 | — | — | — | — | 30 |
| microm with epoxysilane sizing) | | | | | | | |
| Carbon black batch (25% Printex 60 | — | 0.4 | — | — | — | — | 0.4 |
| in B4500) | | | | | | | |
| Si-Beta (TWRD) | — | — | 1 | — | — | — | — |
| Si-Beta (BASF) | — | — | — | 1 | — | — | 1 |
| Si-MFI (Silicalite-1) | — | — | — | — | 1 | — | — |
| Si-MFI (TCP9024) | — | — | — | — | — | 1 | — |

For Comparative Examples 0-6 and Examples 1-7 in accordance with the present invention (see tables 2 and 3), the poly(butylene terephthalate) (water content below 0.04 weight-%), the polyacrylic acid, and the lubricant were extruded together with the zeolitic material in a twin-screw extruder at melt temperature of 240° C. on a DSM mini-extruder. The poly(butylene terephthalate) and the zeolitic material were weighted in and dried overnight at 80° C. The resulting dry mixture was filled into a pre-heated DSM mini-extruder and the polyacrylic acid solution was added. The mixture was compounded for 3 minutes and after this time the melt was released and granulated.

For Comparative Examples 7-8 and Examples 8-12 in accordance with the present invention, the poly(butylene terephthalate) (water content below 0.04 weight-%) and the polyacrylic acid was extruded together with the zeolitic material in a twin-screw extruder (ZE40AUTXi) at melt temperature from 265 to 275° C., total throughput of 80 kg/h, and rotational rate between 190 rpm. The poly(butylene terephthalate) and the zeolitic material were fed cold feed, the polyacrylic acid solution was dosed hot feed (in zone 4 of the extruder). The extruder temperature of the extruder housing was 280° C., the extruder had a length/diameter ration of 30 and a nozzle of 5×4 mm. The composition of the examples can be found in table 4. The resulting extrudate was granulated into granulate which could be used further. The specimens were analyzed using GC as can be read below. The granulate was further processed into plaques measuring 60×60×1 mm using injection molding. Injection molding was performed using a melt temperature of 260° C., a mold temperature of 60° C. and an injection pressure between 150 to 1000 bar. The samples shown in table 4 have been prepared using this method.

### Example 13: Determination of the VOC Outgassing

Emission analysis was carried out in accordance with VDA 277, a standard method of the Auto-mobile Industry Association for the determination of TOC (=total organic carbon emission). VDA 277 is used to investigate the carbon emission of nonmetallic materials used in motor vehicles.

All Comparative Examples 0-8 and Examples 1-12 in accordance with the present invention were tested with regard to their VOC outgassing in accordance with test procedure VDA 277 (German: “Prüfvorschrift VDA 277”; being equivalent to VW-Norm PV3341 of Volkswagen company).

In accordance with VDA 277, the following conditions were applied. Each testing was performed three times and the results were averaged. For one testing, 2 g of a sample comprising a granulate having a weight in the range of from 10 to 25 mg were placed in a sealable cylindrical flask (German: “Head-Space-Gläschen”). The flask was sealed such that it comprised a sample phase and a so-called head-space phase. Then, the granulate was heated to a temperature of 120° C. for 5 h allowing outgassing of the granulate into the head-space phase. After heating, the gas phase was immediately analyzed by gas chromatography and the outgassing determined. The results are shown in table 5 and 6 below.

TABLE 5
Outgassing from Comparative
Examples 0-6 and Examples 1-7 in
accordance with the present invention.

| | THF |
|---|---|
| | outgassing |
| Example | (ppm) |
| Comp. Ex. 0 | 10 |
| Comp. Ex. 1 | 141 |
| Comp. Ex. 2 | 146 |
| Comp. Ex. 3 | 243 |
| Comp. Ex. 4 | 253 |
| Comp. Ex. 5 | 151 |
| Comp. Ex. 6 | 34 |
| Ex. 1 | 7 |
| Ex. 2 | 1.2 |
| Ex. 3 | 0.9 |
| Ex. 4 | 3.8 |
| Ex. 5 | 1.8 |
| Ex. 6 | 5.6 |
| Ex. 7 | 2.0 |

TABLE 6
Outgassing from Comparative example 7 and
Examples 8-12 in accordance with the present invention.

| | THF | THF |
|---|---|---|
| | outgassing | outgassing |
| | granulate | from plate |
| Example | (ppm) | (ppm) |
| Comp. Ex. 7 | 10 | 26.1 |
| Comp. Ex. 8 | 7.8 | 22.1 |
| Ex. 8 | 3.9 | 16.0 |
| Ex. 9 | 0.7 | 2.4 |
| Ex. 10 | 3.7 | 14.3 |
| Ex. 11 | 2.7 | 10.1 |
| Ex. 12 | 0.4 | 1.8 |

As can be seen from the results for the determination of VOC outgassing, all of the Examples 1-12 in accordance with the present invention exhibit comparatively lower emissions than the Comparative Examples 0-8. In particular, comparatively low outgassing has been found for the Examples in accordance with the present invention as regards outgassing determined according to VDA 277. Similarly, the TH F emissions were shown to be comparatively lower for the Examples in accordance with the present invention than for the Comparative Examples.

### Cited Literature

EP 3004242 B1
JP 2019 014826 A
WO 2019/189337 A1
US 2003/195296 A1

1. A molding comprising,
(i) a poly(butylene dicarboxylate) polyester in an amount in a range of from equal to or greater than 10 to 99.99 weight-%, based on a total weight of the molding,
(ii) a zeolitic material in an amount of from 0.01 to 10 weight-%, based on the total weight of the molding,
wherein the zeolitic material comprises YO₂ and optionally X₂O₃, wherein Y is a tetravalent element and X is a trivalent element, wherein the zeolitic material has a YO₂ to X₂O₃ molar ratio of higher than 100 if the zeolitic material comprises X₂O₃.

2. The molding of claim 1, wherein the zeolitic material exhibits, in a temperature programmed desorption of ammonia in a temperature range of from 100 to 500° C., an ammonia adsorption of equal to or smaller than 1.50 μmol/g, wherein the temperature programmed desorption of ammonia is determined according to Reference Example 4.

3. The molding of claim 1, wherein the tetravalent element Y is selected from the group consisting of Si, Sn, Ti, Zr, Ge, and a mixture of two or more thereof.

4. The molding of claim 1, wherein the trivalent element X is selected from the group consisting of B, Al, Ga, In, and a mixture of two or more thereof.

5. The molding of claim 1, wherein the zeolitic material has a framework structure having a maximum ring size of equal to or more than 10 T-atoms.

6. The molding of claim 1, wherein the zeolitic material has a framework structure type selected from the group consisting of BEA, FAU, MFI, MWW, GIS, MOR, LTA, FER, TON, MTT, MEL, MFS, and a mixed structure of two or more thereof.

7. The molding of claim 1, wherein the zeolitic material exhibits a water adsorption in the range of from 1 to 35 weight-%, wherein the water adsorption is determined according to Reference Example 1.

8. The molding of claim 1, wherein the zeolitic material has a volume-based particle size D50 in the range of from 0.5 to 25.0, wherein the volume-based particle size D50 is determined according to Reference Example 6.

9. The molding of claim 1, wherein a dicarboxylate of the poly(butylene dicarboxylate) polyester comprises one or more of adipate, terephthalate, sebacate, azelate, succinate, and 2,5-furandicarboxylate.

10. The molding of any one of claim 1, further comprising an acrylic acid polymer.

11. The molding of claim 1, wherein the molding further comprises one or more additives.

12. The molding of claim 11, wherein the molding comprises the one or more additives in an amount in a range of from greater than 0 to 70 weight-%, based on the total weight of the molding.

13. A process for preparing a molding comprising a poly(butylene) terephthalate and a zeolitic material, the process comprising
(i) preparing a mixture comprising a poly(butylene) terephthalate in an amount in a range of from equal to or greater than 10 to 99.99 weight-%, based on a total weight of the mixture, a zeolitic material in an amount of from 0.01 to 10 weight-%, based on the total weight of the mixture, and optionally one or more additives in an amount in the range of from equal to or greater than 0 to 70 weight-%, based on the total weight of the mixture,
(ii) shaping the mixture obtained from (i),
wherein the zeolitic material comprises YO₂ and optionally X₂O₃, wherein Y is a tetravalent element and X is a trivalent element, and wherein the zeolitic material has a YO₂ to X₂O₃ molar ratio of higher than 100 if the zeolitic material comprises X₂O₃.

14. A molding comprising a poly(butylene dicarboxylate) polyester and a zeolitic material, wherein the molding is obtained by a process according to claim 13.

15. (canceled)

16. The molding according to claim 14 in a shape of a package, a fiber, a film, or a capsule.
